(19) United States
(12) Patent Application Publication
(10) Pub. No.: US 2025/0191543 A1
(43) Pub. Date: Jun. 12, 2025

(54) DISPLAY DEVICE INCLUDING A DATA DRIVING CIRCUIT

(71) Applicant: SAMSUNG DISPLAY CO., LTD., YONGIN-SI (KR)

(72) Inventor: DALE YIM, Yongin-si (KR)

(21) Appl. No.: 18/894,849

(22) Filed: Sep. 24, 2024

(30) Foreign Application Priority Data
Dec. 8, 2023 (KR) 10-2023-0177171

(51) Int. Cl. G09G 3/3275

(52) U.S. Cl. CPC G09G 3/3275; G09G 2310/0291; G09G 2330/021

(57) ABSTRACT

Disclosed is a display device which includes a driving controller, a data driving circuit, a selection circuit, and a display panel. The driving controller performs rendering processing for red, green, and blue input image signals to generate a red, a first green, a blue, and a second green image signal, and converts the red, first green, blue, and second green image signals into red image data, first green image data, blue image data, and second green image data. The data driving circuit converts the red, first green, blue, and second green image data into the red, first green, blue, and second green image signals. The selection circuit selectively outputs the red, first green, blue, and second green image signals.

### CROSS-REFERENCE TO RELATED APPLICATIONS

This application claims priority under 35 U.S.C. § 119 to Korean Patent Application No. 10-2023-0177171, filed on Dec. 8, 2023, in the Korean Intellectual Property Office, the disclosure of which is hereby incorporated by reference in its entirety.

### BACKGROUND

### 1. Technical Field

Embodiments of the present disclosure described herein relate to a display device, and more particularly, relate to a display device including a driving controller configured to convert an image signal into image data configured to reduce power consumption.

### 2. Discussion Description of the Related Art

Light emitting display devices may display an image by using light emitting diodes. A light emitting diode may generate light through the recombination of electrons and holes. These light emitting display devices may be characterized by low power consumption and fast response speed.

Light emitting display devices may include a display panel where pixels connected to data lines and scan lines are disposed. Each of the pixels typically includes a light emitting diode and a pixel circuit unit for controlling an amount of current flowing to the light emitting diode. The pixel circuit unit may control the amount of current flowing through the light emitting diode in response to a data signal. In this case, light may be generated having a luminance corresponding to the amount of current flowing through the light emitting diode.

### SUMMARY

Embodiments of the present disclosure provide a display device including a data driving circuit capable of reducing power consumption.

Embodiments of the present disclosure provide a display device including a data driving circuit configured to convert an image signal into image data configured to reduce power consumption.

According to an embodiment, a display device includes a driving controller, a data driving circuit, a selection circuit, and a display panel. The driving controller performs rendering processing for a red input image signal, a green input image signal, and a blue input image signal to generate a red image signal, a first green image signal, a blue image signal, and a second green image signal, and converts the red image signal, the first green image signal, the blue image signal, and the second green image signal into red image data, first green image data, blue image data, and second green image data. The data driving circuit converts the red image data, the first green image data, the blue image data, and the second green image data into a red data signal, a first green data signal, a blue data signal, and a second green data signal. The selection circuit is connected to the data driving circuit and selectively outputs the red data signal, the first green data signal, the blue data signal, and the second green data signals. The display panel receives the red data signal, the first green data signal, the blue data signal, and the second green data signal and displays an image. At least an n-th value of the first green image signal and an n-th value of the second green image signal have a same value.

According to an embodiment, a display device includes a rendering processing unit, a dithering processing unit, a flag signal generating unit, a data driving circuit, a selection circuit, and a display panel.

The rendering processing unit receives a red input image signal, a green input image signal, and a blue input image signal and performs rendering processing for the red input image signal, the green input image signal, and the blue input image signal to generate a first red image signal, a first green image signal, a first blue image signal, and a second green image signal. The dithering processing unit performs dithering processing for the first red image signal, the first green image signal, the first blue image signal, and the second green image signal based on a dithering map to convert the red image signal, the first green image signal, the blue image signal, and the second green image signal into first red image data, first green image data, first blue image data, and second green image data. The flag signal generating unit generates a flag signal based on the dithering map.

The data driving circuit receives the first red image data, the first green image data, the first blue image data, and the second green image data and converts the first red image data, the first green image data, the first blue image data, and the second green image data into a first red data signal, a first green data signal, a first blue data signal, and a second green data signal. The selection circuit is connected to the data driving circuit and includes a first and a second switching circuit selectively outputting the first red data signal and the first blue data signal and a third and a fourth switching circuit selectively outputting the first green data signal and second green data signal. The display panel receives the first red data signal, the first green data signal, the first blue data signal, and the second green data signal and displays an image. Operations of the third switching circuit and the fourth switching circuit are controlled by the flag signal.

According to an embodiment, a display device includes a dithering processing unit configured to perform dithering processing for a first red image signal and a first blue image signal based on a dithering map, and to perform dithering pre-processing for a first green image signal and a second green image signal to convert the first red image signal, the first green image signal, the first blue image signal, and the second green image signal into first red image data, first green image data, first blue image data, and second green image data, a data driving circuit configured to convert the first red image data, the first green image data, the first blue image data, and the second green image data into a first red data signal, a first green data signal, a first blue data signal, and a second green data signal, a selection circuit connected to the data driving circuit and including a first switching circuit and a second switching circuit selectively outputting the first red data signal, the first green data signal, the first blue data signal, and the second green data signal, and a display panel configured to receive the first red data signal, the first green data signal, the first blue data signal, and the second green data signal and to display an image, wherein the first green image data and the second green image data are matching signals.

According to an embodiment, a display device includes a rendering processing unit configured to receive a red input image signal, a green input image signal, and a blue input image signal and to perform rendering processing for the red input image signal, the green input image signal, and the blue input image signal to generate a first red image signal, a first green image signal, a first blue image signal, and a second green image signal, a dithering processing unit configured to perform dithering processing for the first red image signal, the first green image signal, the first blue image signal, and the second green image signal based on a dithering map, so as to be converted into first red image data, first green image data, first blue image data, and second green image data, a flag signal generating unit configured to generate a flag signal based on the dithering map, a data driving circuit configured to receive the first red image data, the first green image data, the first blue image data, and the second green image data and to convert the first red image data, the first green image data, the first blue image data, and the second green image data into a first red data signal, a first green data signal, a first blue data signal, and a second green data signal, a selection circuit connected to the data driving circuit and including a first switching circuit and a second switching circuit selectively outputting the first red data signal and the first blue data signal and a third switching circuit and a fourth switching circuit selectively outputting the first green data signal and the second green data signal, and a display panel configured to receive the first red data signal, the first green data signal, the first blue data signal, and the second green data signal and to display an image, wherein a simultaneous operation timing of the third switching circuit and the fourth switching circuit are determined by the flag signal . . .

### BRIEF DESCRIPTION OF THE FIGURES

The above and other objects and features of the present disclosure will become apparent by describing in detail embodiments thereof with reference to the accompanying drawings.

FIG. 1 is a perspective view of an electronic device according to an embodiment of the present disclosure.

FIG. 2A is an exploded perspective view of an electronic device according to an embodiment of the present disclosure.

FIG. 2B is a cross-sectional view of a display device according to an embodiment of the present disclosure.

FIG. 3 is a block diagram of a display device according to an embodiment of the present disclosure.

FIG. 4 is a block diagram of a driving controller according to an embodiment of the present disclosure.

FIG. 5A is a diagram illustrating red, green, and blue input image signals according to an embodiment of the present disclosure.

FIG. 5B is a diagram illustrating red, green, and blue image signals according to an embodiment of the present disclosure.

FIG. 5C is a diagram illustrating red, green, and blue image data according to an embodiment of the present disclosure.

FIG. 5D is a diagram illustrating a flag signal according to an embodiment of the present disclosure.

FIG. 6A, FIG. 6B, FIG. 6C, FIG. 6D, FIG. 6E, FIG. 6F, FIG. 6G, and FIG. 6H are diagrams illustrating eight frame-specific dithering maps according to an embodiment of the present disclosure.

FIG. 7 is a circuit diagram illustrating a configuration of a selection circuit according to an embodiment of the present disclosure.

FIG. 8A and FIG. 8B are diagrams for describing operations of third and fourth switching circuits according to an embodiment of the present disclosure.

FIG. 9A and FIG. 9B are diagrams for describing operations of third to sixth switching circuits according to an embodiment of the present disclosure.

FIG. 10 is a block diagram of a driving controller according to an embodiment of the present disclosure.

FIG. 11 is a diagram illustrating red, green, and blue image data according to an embodiment of the present disclosure.

FIG. 12 is a circuit diagram illustrating a configuration of a selection circuit according to an embodiment of the present disclosure.

### DETAILED DESCRIPTION

In the specification, the expression that a first component (or an area, a layer, a part, or a portion) is “on”, “connected to”, or “coupled to” a second component means that the first component may be directly on/connected to/coupled to the second component or means that a third component is interposed therebetween. The expression that the first component is “directly disposed on”, “directly connected with”, or “directly coupled with” the second component means that no third component is interposed between the first component and the second component.

The same reference numerals/signs refer to the same components. In addition, in the drawings, thicknesses, proportions, and dimensions of components may be exaggerated to describe the technical features effectively. The expression “and/or” may include one or more combinations in which associated components are capable of defining.

Although the terms “first”, “second”, etc. may be used to describe various components, the components should not be construed as being limited by the terms. The terms may be used to distinguish one component from another component. For example, without departing from the scope and spirit of the invention, a first component may be referred to as a “second component”, and similarly, the second component may be referred to as the “first component”. The singular forms are intended to include the plural forms unless the context clearly indicates otherwise.

Also, the terms “under”, “below”, “on”, “above”, etc. may be used to describe the correlation of components illustrated in drawings. The terms are relative and are described with respect to a direction indicated in the drawing.

It will be further understood that the terms “comprises”, “includes”, “have”, etc. specify the presence of stated features, numbers, steps, operations, elements, components, or a combination thereof, but do not preclude the presence or addition of one or more other features, numbers, steps, operations, elements, components, or a combination thereof.

Unless otherwise defined, all terms (including technical terms and scientific terms) used in the specification have the same meaning as commonly understood by one skilled in the art to which the present disclosure belongs. Furthermore, terms defined in the dictionaries and commonly used should be interpreted as having a meaning consistent with the meaning in the context of the related technology, and should not be interpreted in ideal or overly formal meanings unless explicitly defined herein.

Hereinafter, embodiments of the present disclosure will be described with reference to accompanying drawings.

According to an embodiment, an electronic device including a display device may convert an image signal into image data that may be displayed by the display device. Embodiments of the present disclosure are directed to a display device including a driving controller configured to convert an image signal into image data configured to reduce power consumption.

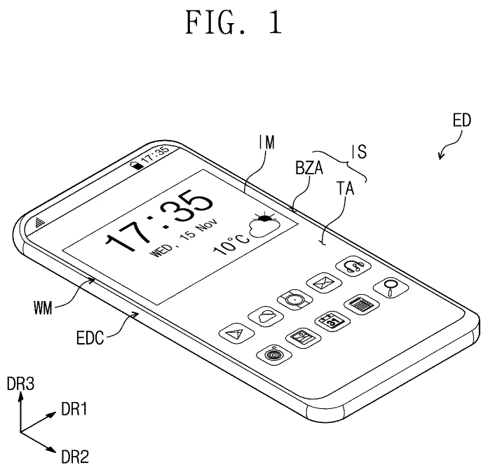

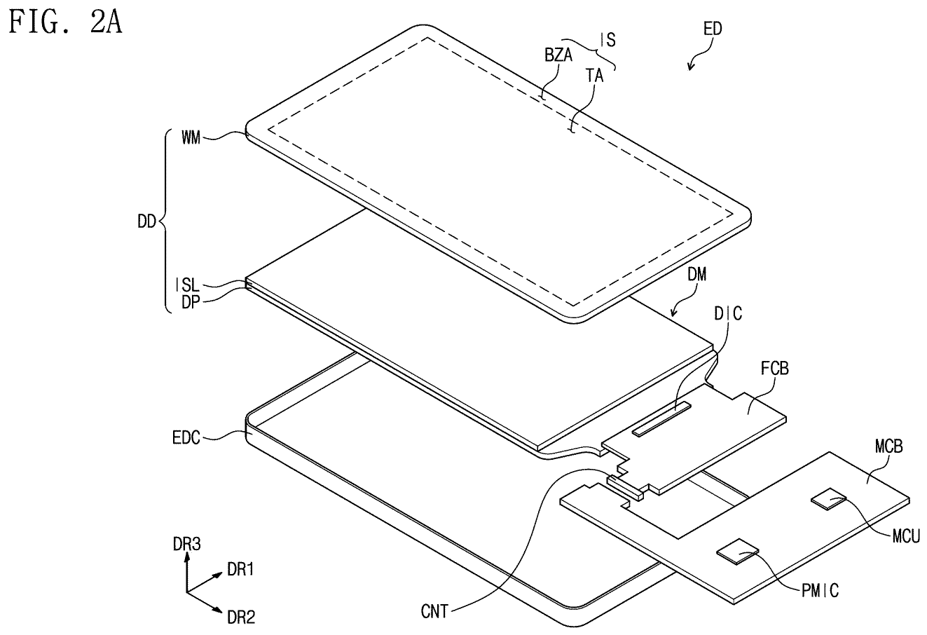

FIG. 1 is a perspective view of an electronic device according to an embodiment of the present disclosure.

Referring to FIG. 1, an electronic device ED according to an embodiment of the present disclosure may be provided. The electronic device ED may be in the shape of a rectangle having first sides parallel to a first direction DR1 and second sides parallel to a second direction DR2 intersecting the first direction DR1. The first sides may be relatively short sides and the second sides may be relatively long sides. However, the present disclosure is not limited thereto. For example, the electronic device ED may be implemented in various shapes such as a circle and a polygon.

The electronic device ED may be a device which is activated depending on an electrical signal. The electronic device ED may be implemented in various applications. For example, the electronic device ED may be implemented in an electronic device such as a smartphone, a smart watch, a tablet, a notebook, a computer, a smart television, or a navigation system.

Herein, a normal direction may be substantially perpendicular to a plane defined by a first direction DR1 and a second direction DR2, and may be defined as a third direction DR3. In the specification, the expression “when viewed from above a plane” may mean “when viewed in the third direction DR3”.

An upper surface of the electronic device ED may be a display surface IS and may be disposed parallel to the plane defined by the first direction DR1 and the second direction DR2. Images IM generated by the electronic device ED may be perceived by a user through the display surface IS.

The display surface IS may be divided into a transparent area TA and a bezel area BZA. The transparent area TA may be an area in which the images IM may be displayed. The user may visually perceive the images IM through the transparent area TA. In an embodiment, the transparent area TA is illustrated in the shape of a quadrangle whose vertexes are rounded. However, the present disclosure is not limited thereto, and the transparent area TA may be implemented in various shapes and may not be limited to any one embodiment.

The bezel area BZA may be disposed adjacent to the transparent area TA. The bezel area BZA may have a given color. The bezel area BZA may surround the transparent area TA. Accordingly, the shape of the transparent area TA may be defined substantially by the bezel area BZA. However, the present disclosure is not limited thereto, for example, the bezel area BZA may be disposed adjacent to one side of the transparent area TA or may be omitted.

The electronic device ED may sense an external input applied from the outside. The external input may include various types of inputs, which may be provided from the outside of the electronic device ED. For example, as the external input may be provided by a contact made by a part of the human body such as the user's hand or a contact made by a separate device (e.g., an active pen or a digitizer). The external input may include an external input (e.g., hovering), which may be applied in a state where the user's hand comes close to the electronic device ED or is adjacent to the electronic device ED within a given distance. Also, various types of the external input may be provided including a force type input, a pressure type input, a temperature type input, or a light type input.

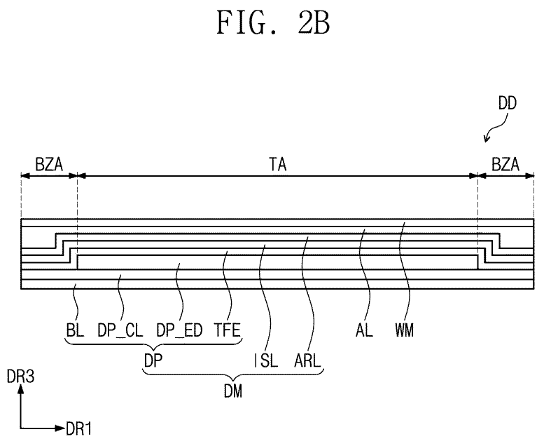

FIG. 2A is an exploded perspective view of an electronic device according to an embodiment of the present disclosure. FIG. 2B is a cross-sectional view of a display device according to an embodiment of the present disclosure.

Referring to FIG. 2A and FIG. 2B, the electronic device ED may include a display device DD, an electronic module (described herein), and a housing EDC. The display device DD may include a window WM and a display module DM. The display device DD may be accommodated in the housing EDC. In an embodiment, the electronic device ED may be implemented by coupling the window WM and the housing EDC.

A front surface of the window WM may define a display surface IS of the electronic device ED. The window WM may include an optically transparent material. For example, the window WM may include glass or plastic. The window WM may be implemented in a multi-layer structure or a single-layer structure. For example, the window WM may include a plurality of plastic films bonded to each other by an adhesive, or may have a glass substrate and a plastic film bonded to each other by an adhesive.

The display module DM may include a display panel DP and an input sensing layer ISL. The display panel DP may display an image depending on an electrical signal, and the input sensing layer ISL may sense an external input applied from the outside.

The display panel DP according to an embodiment of the present disclosure may be a light emitting display panel. However, the display panel DP is not particularly limited thereto. For example, the display panel DP may be an organic light emitting display panel, an inorganic light emitting display panel, or a quantum dot light emitting display panel. A light emitting layer of the organic light emitting display panel may include an organic light emitting material, and a light emitting layer of the inorganic light emitting display panel may include an inorganic light emitting material. A light emitting layer of the quantum dot light emitting display panel may include a quantum dot or a quantum rod. Herein, aspects of the present disclosure will be described in the context of an example of the display panel DP implemented as an organic light emitting display panel.

Referring to FIG. 2B, the display panel DP may include a base layer BL, a circuit layer DP_CL, an element layer DP_ED, and an encapsulation layer TFE. The display panel DP according to the present disclosure may be a flexible display panel. However, the present disclosure is not limited thereto. For example, the display panel DP may be a foldable display panel, which is folded about a folding axis, or a rigid display panel.

The base layer BL may include a synthetic resin layer. The synthetic resin layer may be a polyimide-based resin layer, and a material thereof is not particularly limited. In addition, the base layer BL may include a glass substrate, a metal substrate, or an organic/inorganic composite material substrate.

The circuit layer DP_CL may be disposed on the base layer BL. The circuit layer DP_CL may be disposed between the base layer BL and the element layer DP_ED. The circuit layer DP_CL may include at least one insulating layer and a circuit element. Herein, the insulating layer included in the circuit layer DP_CL may be referred to as an “intermediate insulating layer”. The intermediate insulating layer may include at least one intermediate inorganic film and at least one intermediate organic film. The circuit element may include a plurality of pixel driving circuits. A pixel driving circuit may be included in each of a plurality of pixels for displaying an image and a sensor driving circuit included in each of a plurality of sensors for recognizing external information. The external information may be biometric information. As an example of the present disclosure, the sensor may include a fingerprint recognition sensor, a proximity sensor, an iris recognition sensor, a blood pressure measurement sensor, or an illumination sensor. Also, the sensor may include an optical sensor which may recognize biometric information by using an optical method. The circuit layer DP_CL may further include signal lines connected to the pixel driving circuit and/or the sensor driving circuit.

The element layer DP_ED may include a plurality of light emitting elements and a plurality of light receiving elements. A light emitting element may be included in each of the pixels and a light receiving element may be included in each of the sensors. As an example of the present disclosure, the light receiving element may be a photodiode. The light receiving element may be a sensor which may sense light reflected by a fingerprint of the user or may otherwise react to light.

The encapsulation layer TFE may seal the element layer DP_ED. The encapsulation layer TFE may include at least one organic film and at least one inorganic film. The inorganic film may include an inorganic material and may protect the element layer DP_ED. For example, the inorganic film may protect the element layer DP_ED from moisture/oxygen. The inorganic layer may include a silicon nitride layer, a silicon oxy nitride layer, a silicon oxide layer, a titanium oxide layer, or an aluminum oxide layer, but is not particularly limited thereto. The organic film may include an organic material and may protect the element layer DP_ED. For example, the organic film may protect the element layer DP_ED from foreign objects such as dust particles.

The input sensing layer ISL may be formed on the display panel DP. The input sensing layer ISL may be directly disposed on the encapsulation layer TFE. According to an embodiment of the present disclosure, the input sensing layer ISL may be formed on the display panel DP through a same process as the display panel DP. That is, when the input sensing layer ISL is directly disposed on the display panel DP, an adhesive film may not be disposed between the input sensing layer ISL and the encapsulation layer TFE. Alternatively, an adhesive film may be disposed between the input sensing layer ISL and the display panel DP. In this case, the input sensing layer ISL may not be manufactured by the same process as the display panel DP. For example, the input sensing layer ISL may be manufactured through a process separate from that of the display panel DP and may then be fixed on the upper surface of the display panel DP by the adhesive film.

The input sensing layer ISL may sense an external input (e.g., a touch of the user), may change the sensed input into a given input signal, and may provide the input signal to the display panel DP. The input sensing layer ISL may include a plurality of sensing electrodes for sensing an external input. The sensing electrodes may sense the external input by using a capacitive method. The display panel DP may receive an input signal from the input sensing layer ISL and may generate an image corresponding to the input signal.

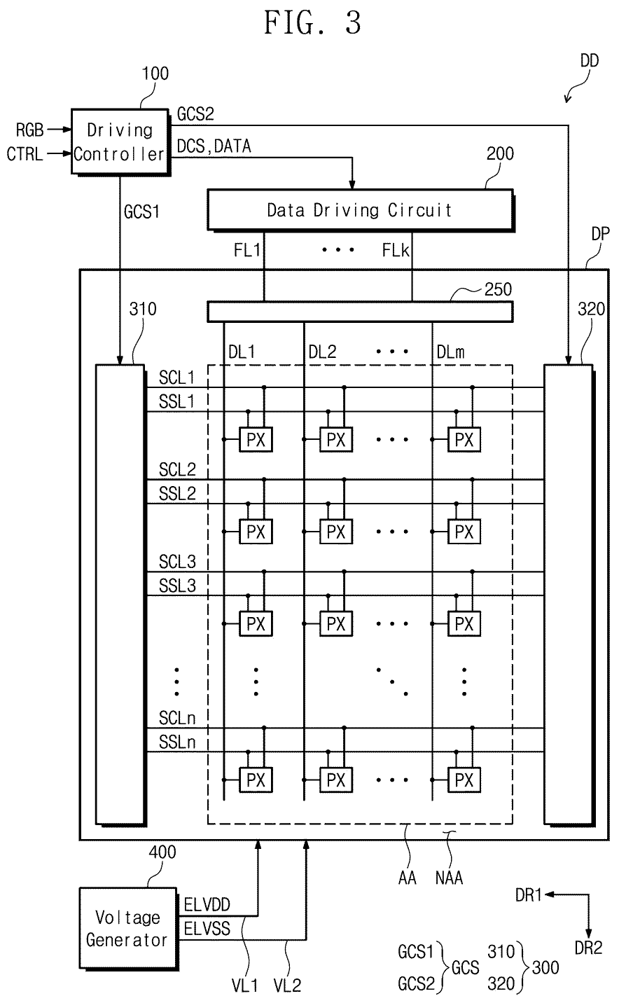

The display module DM may further include an anti-reflection layer ARL. The anti-reflection layer ARL may reduce the reflectance of an external light incident from above the window WM. As an example of the present disclosure, the anti-reflection layer ARL may be disposed on the input sensing layer ISL. However, the present disclosure is not limited thereto. The anti-reflection layer ARL may be disposed between the display panel DP and the input sensing layer ISL. The anti-reflection layer ARL may include a plurality of color filters and a black matrix. The arrangement of the color filters may be determined in consideration of colors of lights generated from a plurality of pixels PX (refer to FIG. 3) included in the display panel DP. Alternatively, the anti-reflection layer ARL may include a phase retarder and a polarizer. The phase retarder may be implemented in a film type or a liquid crystal coating type and may include a λ/2 phase retarder and/or a λ/4 phase retarder. The polarizer may also be implemented in a film type or a liquid crystal coating type. The polarizer of the film type may include a stretch-type synthetic resin film, and the polarizer of the liquid crystal coating type may include liquid crystals arranged in a given direction. The phase retarder and the polarizer may be implemented with a polarization film.

The display device DD according to an embodiment of the present disclosure may further include an adhesive layer AL. The window WM may be attached to the anti-reflection layer ARL. For example, the window WM may be attached to the anti-reflection layer ARL by the adhesive layer AL. The adhesive layer AL may include an optical clear adhesive, an optically clear adhesive resin, or a pressure sensitive adhesive (PSA).

The display module DM may further include a display driving circuit DIC (or a display driving chip) and a flexible circuit film FCB. As an embodiment of the present disclosure, the display driving circuit DIC may be implemented in the shape of a chip and may be mounted on the flexible circuit film FCB. However, the present disclosure is not limited thereto. For example, the display driving circuit DIC may be disposed on the display panel DP.

The flexible circuit film FCB may be coupled to the display panel DP. The flexible circuit film FCB may be coupled to an end portion of the display panel DP such that the display driving circuit DIC may be electrically connected to the display panel DP.

The display module DM may further include a touch driving circuit, which may be mounted on the flexible circuit film FCB and may be electrically connected to the input sensing layer ISL.

The electronic module may include a main circuit board MCB. As an embodiment of the present disclosure, the main circuit board MCB may be electrically connected to the flexible circuit film FCB through a connector CNT. A main processor MCU and a power management integrated circuit (or power management chip) PMIC may be provided on the main circuit board MCB. The main processor MCU and the power management integrated circuit PMIC may be electrically connected to the display driving circuit DIC through the connector CNT.

The main processor MCU may control an overall operation of the electronic device ED. The main processor MCU may include one or more of a central processing unit (CPU) or an application processor (AP). The main processor MCU may further include one or more of a graphic processing unit (GPU), a communication processor (CP), or an image signal processor (ISP). The main processor MCU may provide the display driving circuit DIC with an image signal and various kinds of control signals, which may be used to display an image.

The power management integrated circuit PMIC may receive an external power (e.g., a battery voltage). As an example, the power management integrated circuit PMIC may generate a voltage to be supplied to the display device DD based on the external power. The power management integrated circuit PMIC may include at least one regulator. The at least one regulator may generate output voltages of various voltage levels based on the external power.

A structure where the power management integrated circuit PMIC is mounted on the main circuit board MCB in the shape of a chip is illustrated in FIG. 2A, but the present disclosure is not limited thereto. For example, the power management integrated circuit PMIC may be mounted on the flexible circuit film FCB in the shape of a chip, that is, may be provided as a component included in the display device DD.

The electronic module may further include various functional modules, for example, a camera module or a sensor module, as well as the main circuit board MCB, the main processor MCU, and the power management integrated circuit PMIC.

The housing EDC may be coupled to the window WM. The housing EDC may be coupled to the window WM to provide an inner space. The display device DD and the electronic module may be accommodated in the inner space of the housing EDC. The housing EDC may include a material whose rigidity is relatively high. For example, the housing EDC may include glass, plastic, or metal, or may include a plurality of frames and/or a plurality of plates that may be formed of a combination of two or more of glass, plastic, or metal. The housing EDC may stably protect the components of the display device DD and the electronic module accommodated in the inner space from an external impact.

Although not illustrated, a battery module which supplies a power for the overall operation of the display device DD may be disposed between the display module DM and the housing EDC.

FIG. 3 is a block diagram of a display device according to an embodiment of the present disclosure.

Referring to FIG. 3, the display device DD may include a driving controller 100, a data driving circuit 200, a selection circuit 250, a scan driving circuit 300, a voltage generator 400, and the display panel DP.

The display panel DP may include driving scan lines SCL1 to SCLn, sensing scan lines SSL1 to SSLn, data lines DL1 to DLm, and the pixels PX. Herein, each of “n” and “m” is an integer number of 1 or more. The display panel DP may be divided into an effective area AA and a non-effective area NAA. The pixels PX may be disposed in the effective area AA, and the scan driving circuit 300 may be disposed in the non-effective area NAA.

The driving scan lines SCL1 to SCLn and the sensing scan lines SSL1 to SSLn may extend to be parallel to the first direction DR1 and may be arranged to be spaced apart from each other in the second direction DR2. The second direction DR2 may be a direction intersecting the first direction DR1. The data lines DL1 to DLm may extend in the second direction DR2 and may be arranged to be spaced apart from each other in the first direction DR1. The data lines DL1 to DLm may cross the driving scan lines SCL1 to SCLn and the sensing scan lines SSL1 to SSLn.

The plurality of pixels PX may be electrically connected to the driving scan lines SCL1 to SCLn, the sensing scan lines SSL1 to SSLn, and the data lines DL1 to DLm. Each pixel of the plurality of pixels PX may be electrically connected to two scan lines. However, the number of scan lines connected to each pixel PX is not limited thereto. For example, each pixel PX may be electrically connected to one scan line or three scan lines. The display panel DP may further include sensing lines which may extend in the second direction DR2 and may be arranged in the first direction DR1. In this case, the plurality of pixels PX may be connected to the sensing lines.

Each of the plurality of pixels PX may include a light emitting element and a pixel circuit unit for controlling the emission of the light emitting element. The light emitting element may be an organic light emitting diode. The pixel circuit unit may include a plurality of transistors and at least one capacitor.

The driving controller 100 may receive an input image signal RGB and a control signal CTRL from a main controller (not shown). The main controller may be, for example, a micro controller or a graphics controller. The driving controller 100 may convert the input image signal RGB to generate image data DATA.

The driving controller 100 may generate a scan control signal GCS and a data control signal DCS based on the control signal CTRL. The data driving circuit 200 may receive the data control signal DCS and the image data DATA from the driving controller 100. The data driving circuit 200 may convert the image data DATA into data signals in response to the data control signal DCS. The data driving circuit 200 may output the data signals to the plurality of data lines DL1 to DLm. The data signals may be analog voltages corresponding to gray values of the image data DATA.

As an embodiment of the present disclosure, the data driving circuit 200 may be implemented in the form of at least one chip. For example, the data driving circuit 200 may be included in the display driving circuit DIC illustrated in FIG. 2A. Alternatively, the display driving circuit DIC may further include the driving controller 100. That is, the display driving circuit DIC may be implemented in the form of an integrated chip where the data driving circuit 200 and the driving controller 100 are integrally formed.

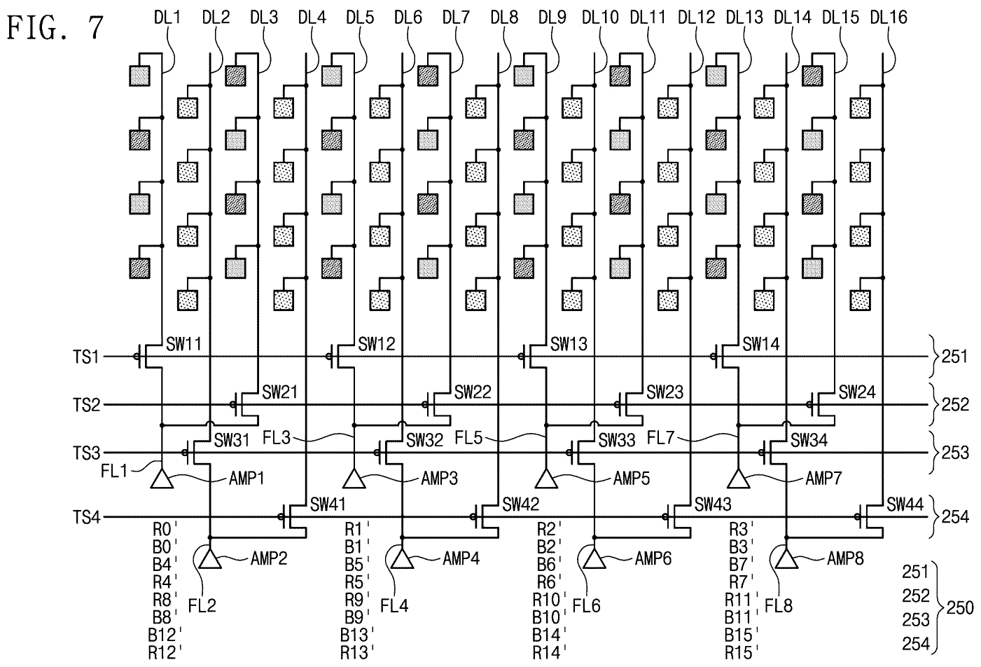

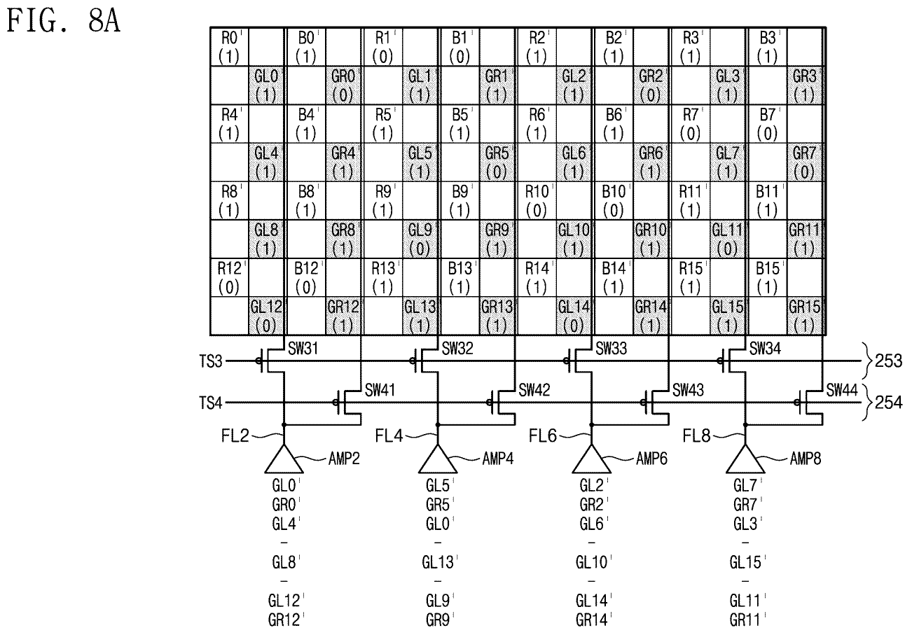

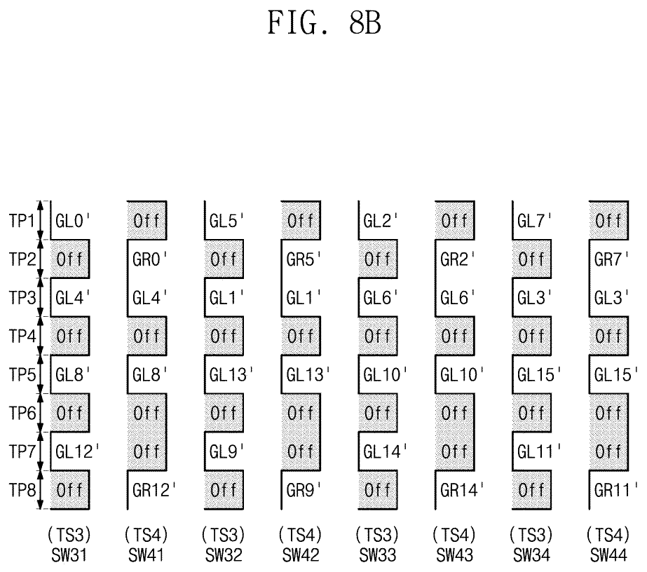

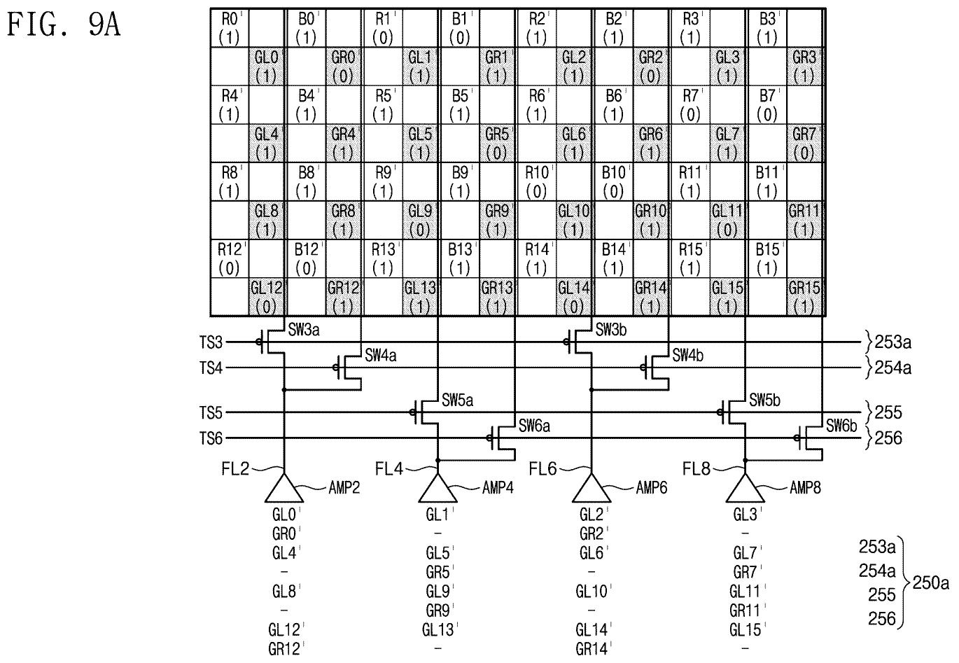

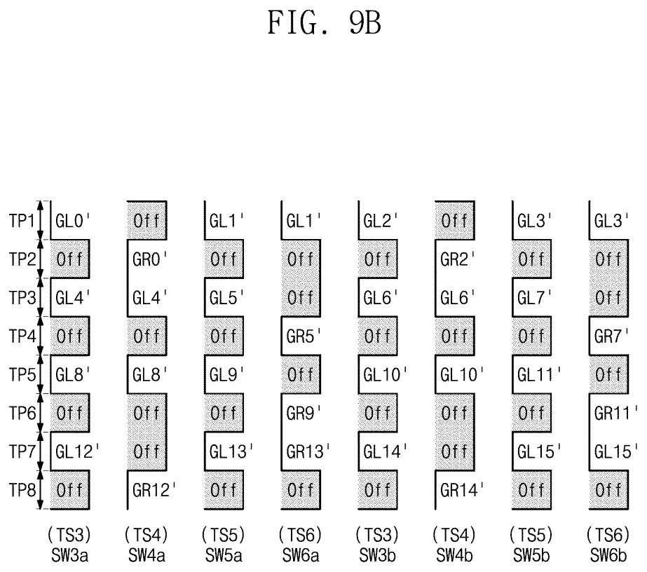

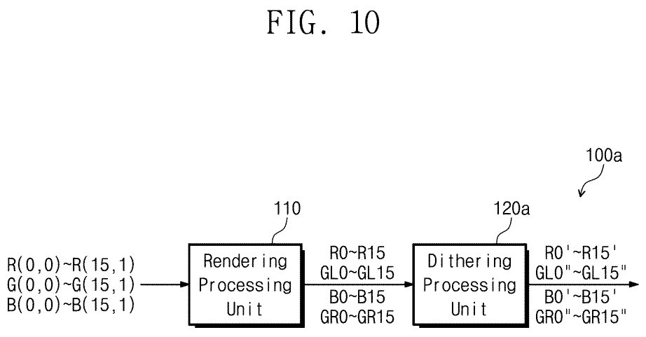

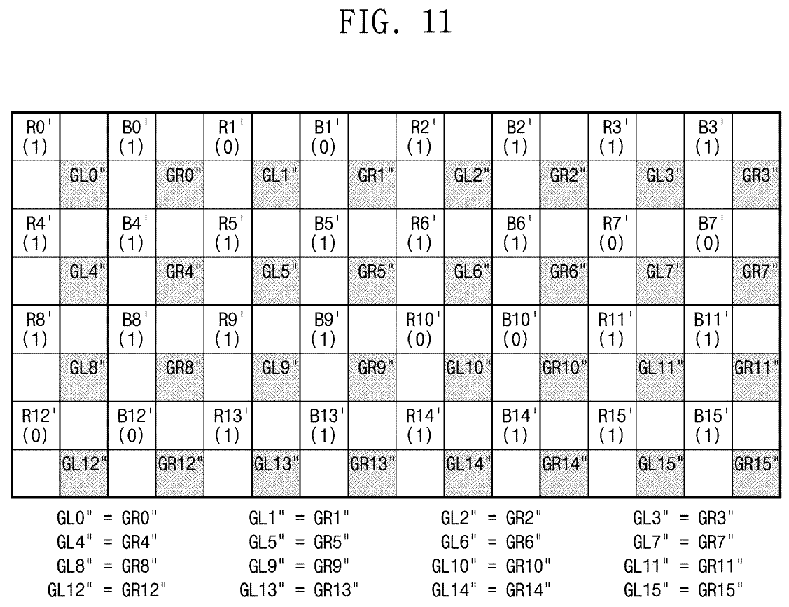

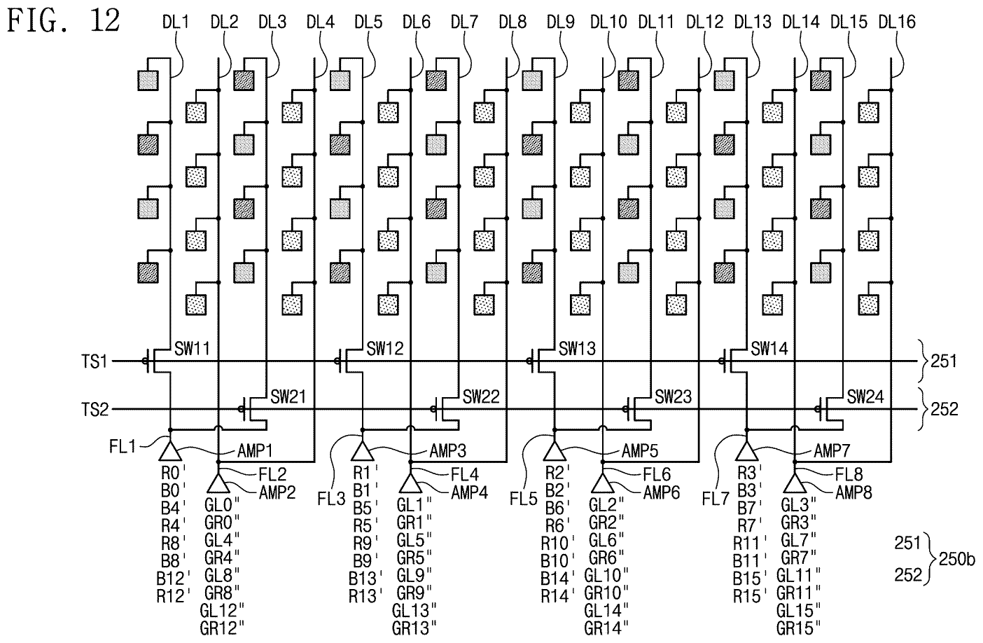

The selection circuit 250 may be disposed between the data lines DL1 to DLm and the data driving circuit 200. The data driving circuit 200 may be electrically connected to the selection circuit 250 through fan-out lines FL1 to FLk. Herein, “k” may be an integer greater than or equal to “1” and smaller than “m”. As an embodiment of the present disclosure, the number of fan-out lines FL1 to FLk (i.e., k) may be ½, ⅓, or ¼ of the number of data lines DL1 to DLm (i.e., m). When the number of fan-out lines FL1 to FLk is ½ of the number of data lines DL1 to DLm (i.e., m), the data lines DL1 to DLm may be divided into two groups (e.g., a first data line group and a second data line group). The selection circuit 250 will be described in detail with reference to FIG. 7, FIG. 8A, FIG. 8B, FIG. 9A, FIG. 9B, FIG. 10, FIG. 11, and FIG. 12.

As an embodiment of the present disclosure, the selection circuit 250 may be disposed in the non-effective area NAA of the display panel DP. In particular, the selection circuit 250 may be formed in the non-effective area NAA through a same process as the pixel circuit unit of each pixel PX. An embodiment in which the selection circuit 250 is disposed in the non-effective area NAA of the display panel DP is illustrated in FIG. 3, but the present disclosure is not limited thereto. Alternatively, the display driving circuit DIC may be implemented in the form of an integrated chip where the data driving circuit 200, the driving controller 100, and the selection circuit 250 are integrally formed. As the data lines DL1 to DLm are selectively driven by using the selection circuit 250, it may be possible to simplify the configuration of the data driving circuit 200 and to reduce the total number of fan-out lines FL1 to FLk.

The scan driving circuit 300 may receive the scan control signal GCS from the driving controller 100. The scan driving circuit 300 may output scan signals in response to the scan control signal GCS. The scan driving circuit 300 may be embedded in the display panel DP. When the scan driving circuit 300 is embedded in the display panel DP, the scan driving circuit 300 may include transistors formed through a same process as the pixel circuit unit of each pixel PX. The scan driving circuit 300 may be disposed in the non-effective area NAA of the display panel DP, but the present disclosure is not limited thereto. Alternatively, the scan driving circuit 300 may overlap at least a portion of the effective area AA of the display panel DP.

The scan driving circuit 300 may generate a plurality of driving scan signals and a plurality of sensing scan signals in response to the scan control signal GCS. The plurality of driving scan signals may be applied to the driving scan lines SCL1 to SCLn, and the plurality of sensing scan signals may be applied to the sensing scan lines SSL1 to SSLn.

As an embodiment of the present disclosure, the scan driving circuit 300 may include a first scan driving circuit 310 and a second scan driving circuit 320. The first scan driving circuit 310 may be disposed on a first side of the effective area AA, and the second scan driving circuit 320 may be disposed on a second side of the effective area AA. The second side may be disposed opposite to the first side. For example, the first side may be a left side of the effective area AA and the second side may be a right side of the effective area AA. The first scan driving circuit 310 may receive a first scan control signal GCS1 from the driving controller 100, and the second scan driving circuit 320 may receive a second scan control signal GCS2 from the driving controller 100. The first scan driving circuit 310 may generate the plurality of driving scan signals and the plurality of sensing scan signals in response to the first scan control signal GCS1. The second scan driving circuit 320 may generate the plurality of driving scan signals and the plurality of sensing scan signals in response to the second scan control signal GCS2.

A structure in which the first and second scan driving circuits 310 and 320 are respectively disposed on the left and right sides of the effective area AA is illustrated in FIG. 3, but the present disclosure is not limited thereto. For example, the scan driving circuit 300 may include the first driving circuit 310 and the second scan driving circuit 320 may be omitted. In another example, the scan driving circuit 300 may include the second scan driving circuit 320 and the first scan driving circuit 310 may be omitted.

Each of the plurality of pixels PX may receive a first driving voltage ELVDD and a second driving voltage ELVSS.

The voltage generator 400 may generate voltages for the operation of the display panel DP. In an embodiment of the present disclosure, the voltage generator 400 may generate the first driving voltage ELVDD and the second driving voltage ELVSS for the operation of the display panel DP. The first driving voltage ELVDD and the second driving voltage ELVSS may be provided to the display panel DP through a first driving voltage line VL1 and a second driving voltage line VL2.

As well as the first driving voltage ELVDD and the second driving voltage ELVSS, the voltage generator 400 may further generate one or more other voltages (e.g., a gamma reference voltage, a data driving voltage, a gate-on voltage, or a gate-off voltage) for operations of the data driving circuit 200 and the scan driving circuit 300.

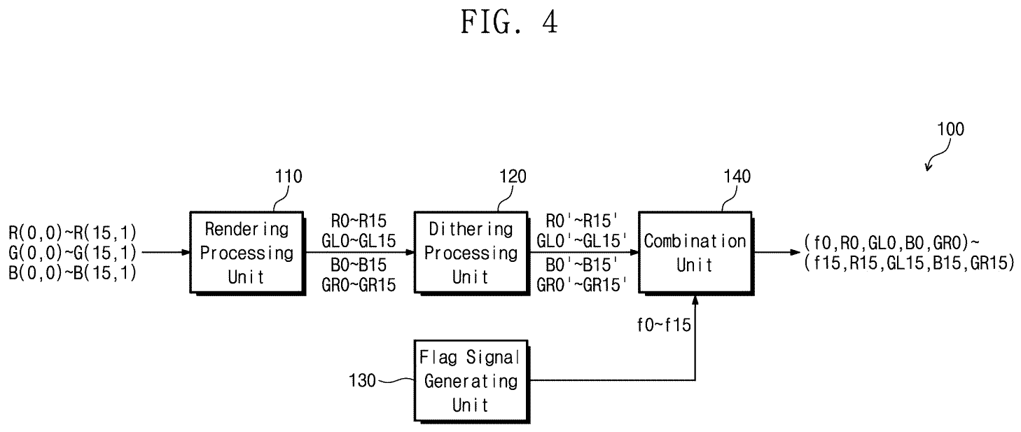

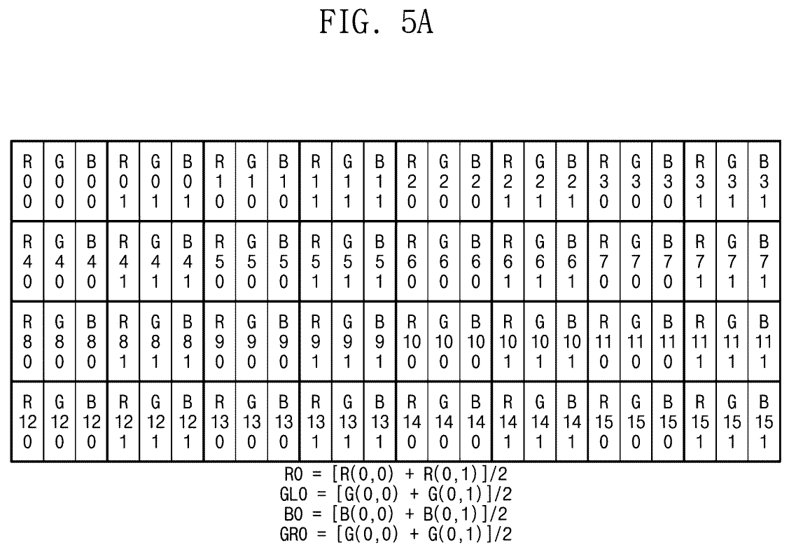

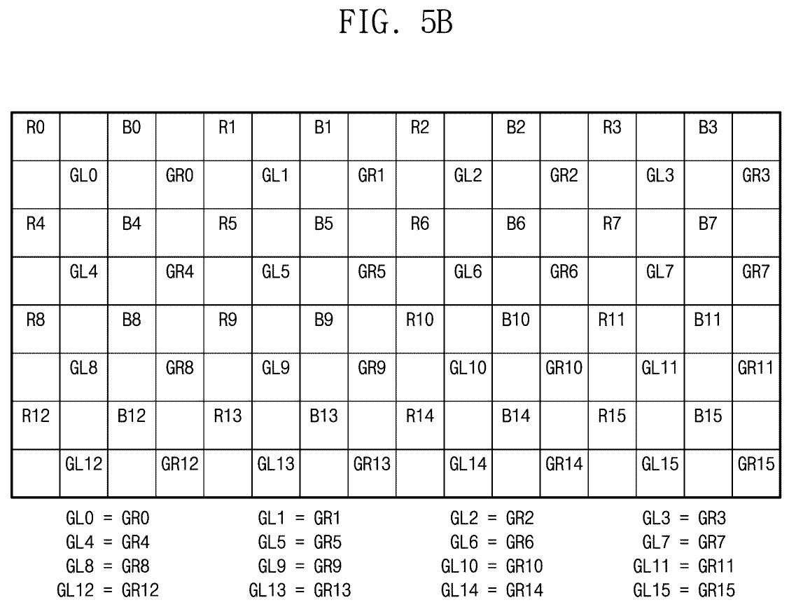

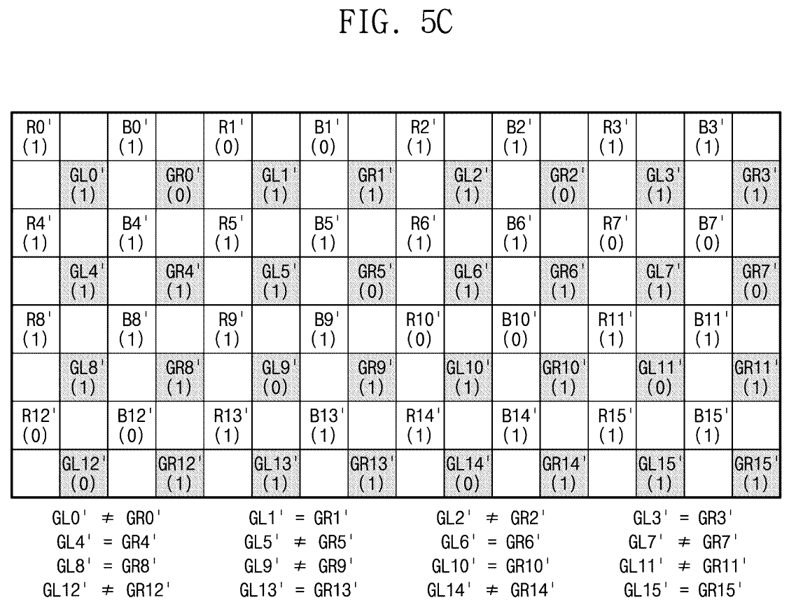

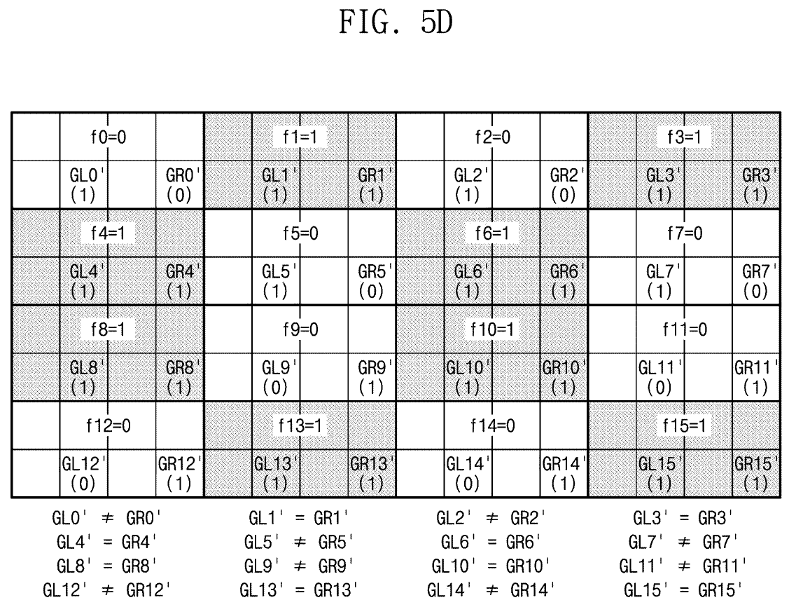

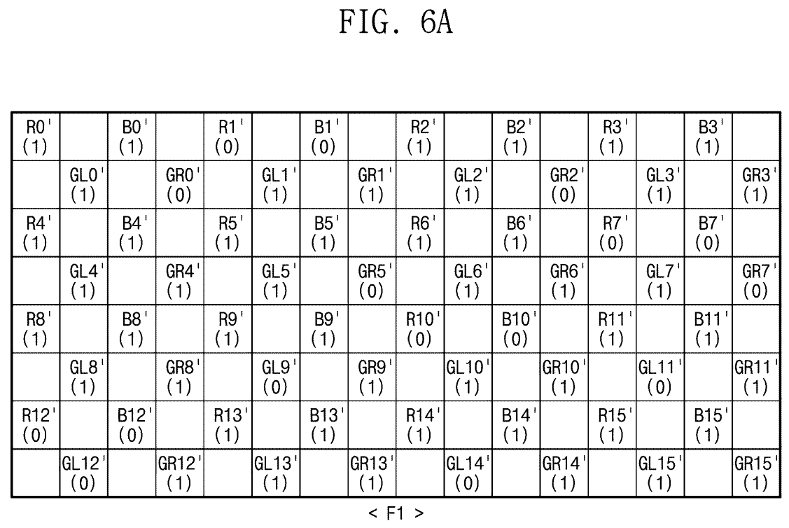

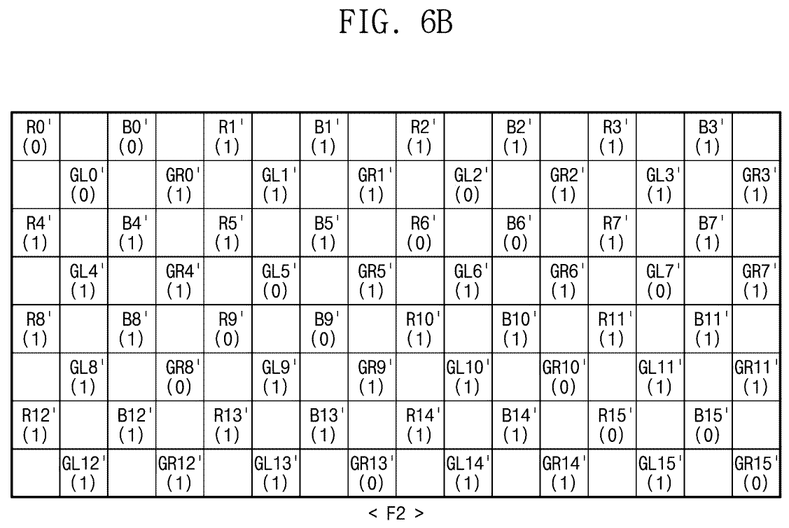

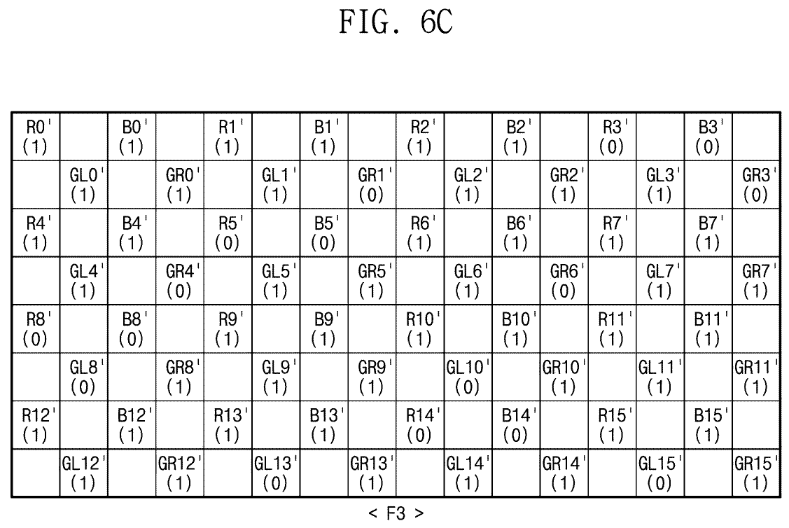

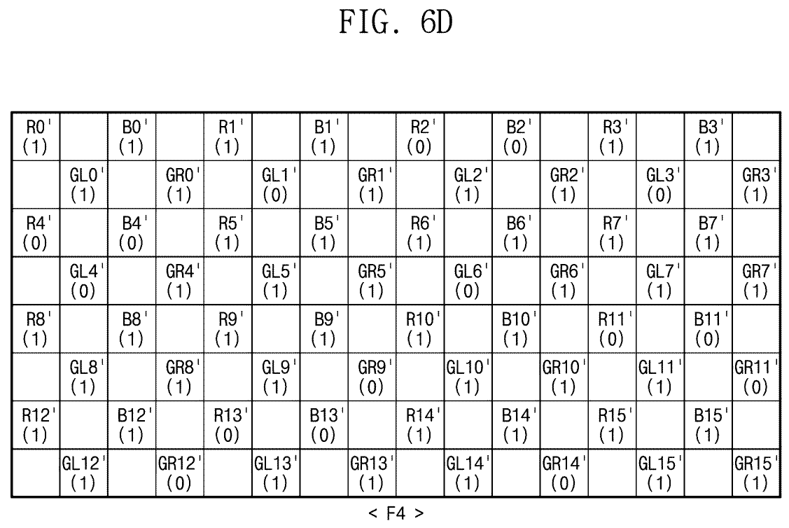

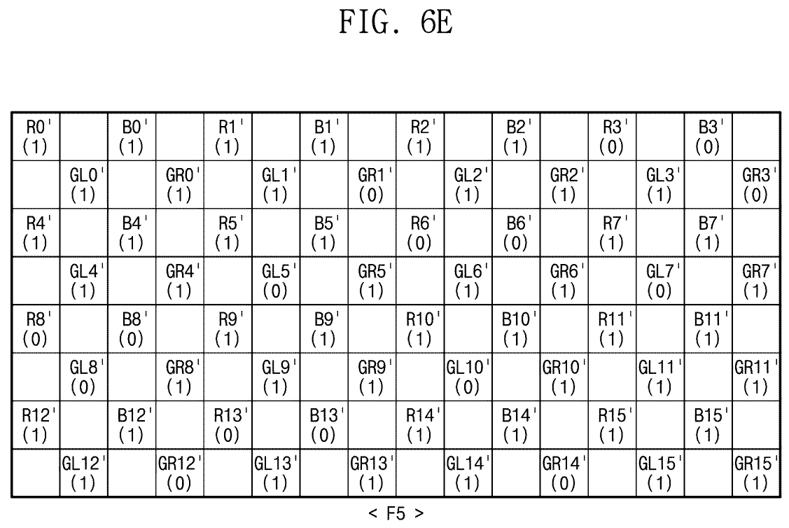

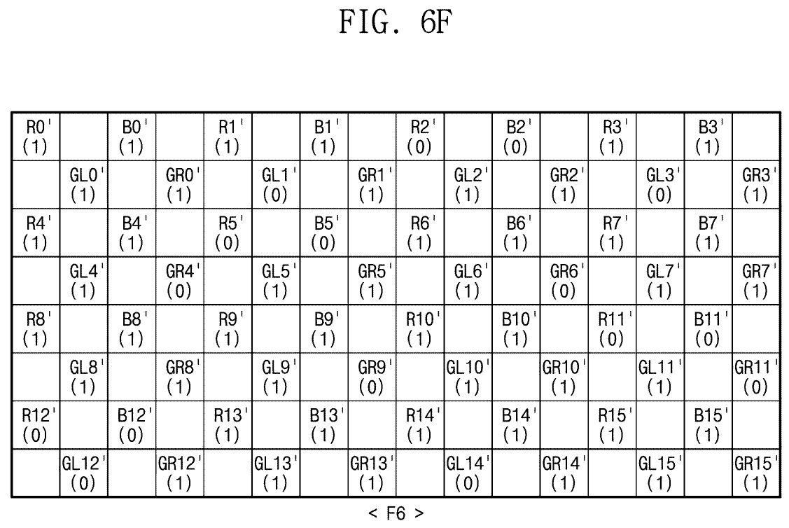

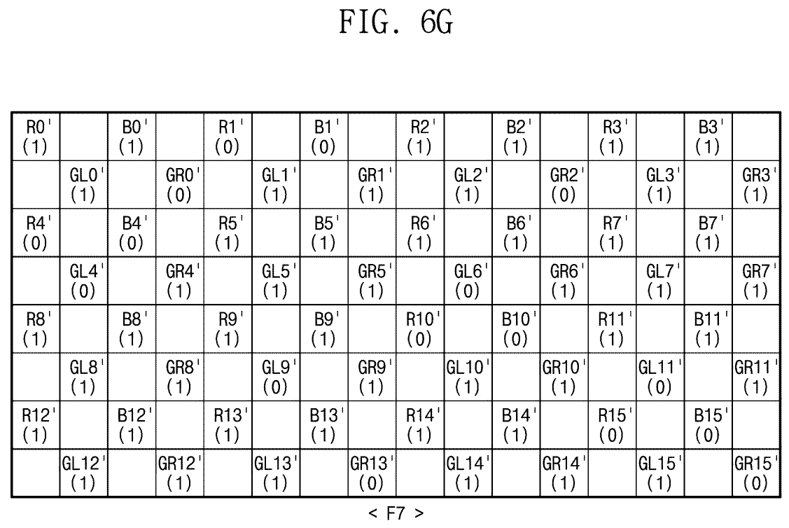

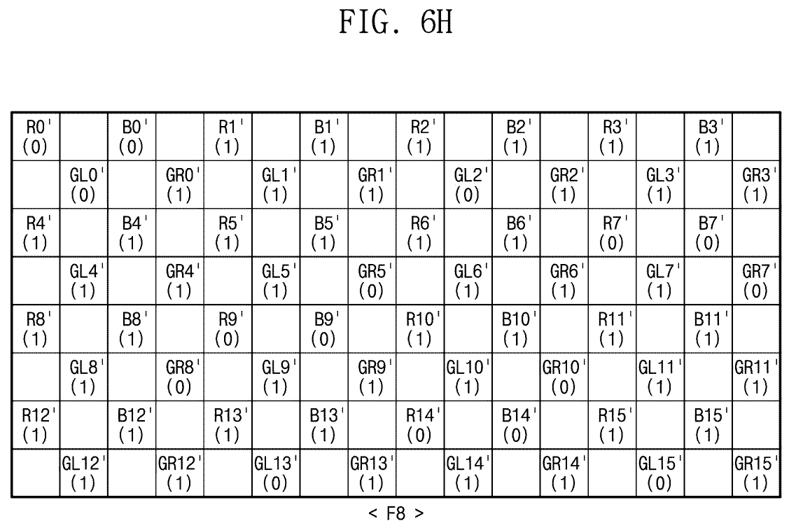

FIG. 4 is a block diagram of a driving controller according to an embodiment of the present disclosure. FIG. 5A is a diagram illustrating red input image signals, green input image signals, and blue input image signals according to an embodiment of the present disclosure. FIG. 5B is a diagram illustrating red image signals, green image signals, and blue image signals according to an embodiment of the present disclosure. FIG. 5C is a diagram illustrating red image data, green image data, and blue image data according to an embodiment of the present disclosure. FIG. 5D is a diagram illustrating a flag signal according to an embodiment of the present disclosure. FIG. 6A, FIG. 6B, FIG. 6C, FIG. 6D, FIG. 6E, FIG. 6F, FIG. 6G, and FIG. 6H are diagrams illustrating eight frame-specific dithering maps according to an embodiment of the present disclosure.

According to an embodiment, a display device may implement a dithering process to improve a displayed image. For example, dithering may be used for inhibiting or preventing large-scale patterns from manifesting in the displayed image. In another example, dithering may be used to produce a perception of colors or patterns, for example, an impression of an orange color may be generated by presenting a pattern of yellow and red pixels. Embodiments of the present disclosure are directed to a dithering process, and a display device implementing a dithering process converting an image signal into image data configured to reduce power consumption of the display device.

Referring to FIG. 4, the driving controller 100 may include a rendering processing unit 110, a dithering processing unit 120, a flag signal generating unit 130, and a combination unit 140.

The rendering processing unit 110 may receive the input image signals RGB, may perform rendering processing for the input image signals RGB, and may output image signals. As an embodiment of the present disclosure, the input image signals RGB may include red input image signals R(0,0) to R(15,1), green input image signals G(0,0) to G(15,1), and blue input image signals B(0,0) to B(15,1). As an embodiment of the present disclosure, each of the red input image signals R(0,0) to R(15,1), the green input image signals G(0,0) to G(15,1), and the blue input image signals B(0,0) to B(15,1) may be a 10-bit digital signal or a 12-bit digital signal.

The rendering processing unit 110 may perform rendering processing for the red input image signals R(0,0) to R(15,1) to generate red image signals R0 to R15 and may perform rendering processing for the blue input image signals B(0,0) to B(15,1) to generate blue image signals B0 to B15. Also, the rendering processing unit 110 may perform rendering processing for the green input image signals G(0,0) to G(15,1) to generate first green image signals GL0 to GL15 and second green image signals GR0 to GR15. As an embodiment of the present disclosure, each of the red image signals R0 to R15, the first green image signals GL0 to GL15, the blue image signals B0 to B15, and the second green image signals GR0 to GR15 may be a 10-bit signal or a 12-bit signal.

As illustrated in FIG. 5A and FIG. 5B, the first red image signal R0 among the red image signals R0 to R15 may be a signal generated by performing rendering for the first red input image signal R(0,0) and the second red input image signal R(0,1). For example, the first red image signal R0 may be an average value of the first red input image signal R(0,0) and the second red input image signal R(0,1), and the second red image signal R1 may be an average value of the third red input image signal R(1,0) and the fourth red input image signal R(1,1). The third to sixteenth red image signals R2 to R15 among the red image signals R0 to R15 may also be generated in a manner similar to that of the first red image signal R0 and the second red image signal R1.

The first blue image signal B0 among the blue image signals B0 to B15 may be a signal generated by performing rendering for the first blue image signal B(0,0) and the second blue image signal B(0,1). For example, the first blue image signal B0 may be an average value of the first blue image signal B(0,0) and the second blue input image signal B(0,1). The second to sixteenth blue image signals B2 to B15 among the blue image signals B0 to B15 may also be generated in a manner similar to that of the first blue image signal B0.

As illustrated in FIG. 5A and FIG. 5B, the (1-1)-th green image signal GL0 among the first green image signals GL0 to GL15 may be a signal generated by performing rendering for the (1-1)-th green input image signal G(0,0) and the (1-2)-th green input image signal G(0,1). For example, the (1-1)-th green image signal GL0 may be an average value of the (1-1)-th green input image signal G(0,0) and the (1-2)-th green input image signal G(0,1). The (2-1)-th green image signal GR0 among the second green image signals GR0 to GR15 may be a signal generated by performing rendering for the (1-1)-th green input image signal G(0,0) and the (1-2)-th green input image signal G(0,1). For example, the (2-1)-th green image signal GR0 may be an average value of the (1-1)-th green input image signal G(0,0) and the (1-2)-th green input image signal G(0,1). Accordingly, as an embodiment of the present disclosure, the (1-1)-th green image signal GL0 may have a same value as the (2-1)-th green image signal GR0. That is, at least an n-th value of the first green image signals GL0 to GL15 and an n-th value of the second green image signals GR0 to GR15 have a same value.

The (1-2)-th to (1-16)-th green image signals GL1 to GL15 among the first green image signals GL0 to GL15 may also be generated in a manner similar to that of the (1-1)-th green image signal GL0, and the (2-2)-th to (2-16)-th green image signals GR1 to GR15 among the second green image signals GR0 to GR15 may also be generated in a manner similar to that of the (2-1)-th green image signal GR0. Accordingly, as an embodiment of the present disclosure, the (1-2)-th to (1-16)-the green image signals GL1 to GL15 and the (2-2)-th to (2-16)-th green image signals GR1 to GR15 may be matching signals, wherein each of the (1-2)-th to (1-16)-th green image signals GL1 to GL15 may have a same value as each of the (2-2)-th to (2-16)-th green image signals GR1 to GR15.

Referring to FIG. 4, FIG. 5B, and FIG. 5C, the dithering processing unit 120 may receive the red image signals R0 to R15, the first green image signals GL0 to GL15, the blue image signals B0 to B15, and the second green image signals GR0 to GR15 from the rendering processing unit 110. The dithering processing unit 120 may perform dithering processing for the red image signals R0 to R15, the first green image signals GL0 to GL15, the blue image signals B0 to B15, and the second green image signals GR0 to GR15. The dithering processing unit 120 may perform dithering processing for the red image signals R0 to R15, the first green image signals GL0 to GL15, the blue image signals B0 to B15, and the second green image signals GR0 to GR15 based on a preset dithering map. The dithering processing unit 120 may perform dithering processing for the red image signals R0 to R15 so as to convert the red image signals R0 to R15 into red image data R0′ to R15′. The dithering processing unit 120 may perform dithering processing for the first green image signals GL0 to GL15 so as to convert the first green image signals GL0 to GL15 into first green image data GL0′ to GL15′. The dithering processing unit 120 may perform dithering processing for the blue image signals B0 to B15 so as to convert the blue image signals B0 to B15 into blue image data B0′ to B15′. The dithering processing unit 120 may perform dithering processing for the second green image signals GR0 to GR15 so as to convert the second green image signals GR0 to GR15 into second green image data GR0′ to GR15′. As an embodiment of the present disclosure, each of the red image data R0′ to R15′, the first green image data GL0′ to GL15′, the blue image data B0′ to B15′, and the second green image data GR0′ to GR15′ may be an 8-bit data.

The dithering processing may include dithering pre-processing, which may remove “k” lower bits of a p-bit image signal so as to convert the p-bit image signal into a q-bit image signal and dithering post-processing, which may add a dither bit to the q-bit image signal based on a dithering map so as to convert the q-bit image signal into q-bit image data. Herein, “p” may be greater than “q”, and “q” may be greater than “k”. In an embodiment, a value of “k” may correspond to “p-q”. For example, when “p” is 12, “k” may be 4, and “q” may be 8. Alternatively, when “p” is 10, “k” may be 2, and “q” may be 8. As an example of the present disclosure, the number of dither bits may be “1”. For example, when a 12-bit image signal is “0111_1111_1100”, an 8-bit image signal, that is, an image signal of “0111_1111” may be obtained by removing 4 lower bits from the 12-bit image signal, and then, 8-bit image data, that is, image data of “1000_0000” may be generated by adding the dither bit to the image signal of “0111_1111”.

As an embodiment of the present disclosure, the dithering map may include a red dithering map as a first dithering map, a first green dithering map as a third dithering map, a blue dithering map as a second dithering map, and a second green dithering map as a fourth dithering map. The red dithering map may include dithering valid values respectively corresponding to the red image signals R0 to R15. As illustrated in FIG. 5C, each of the red and blue dithering maps may be arranged in a 4×4 matrix. The red dithering map may include 16 dithering valid values 1011, 1110, 1101, and 0111 respectively corresponding to the 16 red image signals R0 to R15. The blue dithering map may include 16 dithering valid values 1011, 1110, 1101, and 0111 respectively corresponding to the 16 blue image signals B0 to B15. As an embodiment of the present disclosure, the dithering valid values included in the blue dithering map may be the same as the dithering valid values included in the red dithering map.

Each dithering valid value may be logic “1” or logic “0”; when the dithering valid value is logic “1”, the dithering processing unit 120 may perform both dithering pre-processing and dithering post-processing for a relevant image signal; when the dithering valid value is logic “0”, the dithering processing unit 120 may perform dithering pre-processing for the relevant image signal and may not perform dithering post-processing.

As illustrated in FIG. 6A, FIG. 6B, FIG. 6C, FIG. 6D, FIG. 6E, FIG. 6F, FIG. 6G, and FIG. 6H, the red and blue dithering maps may be repeated every preset number of frames. As an embodiment of the present disclosure, when k (e.g., 4) lower bits are removed in dithering pre-processing, the red and blue dithering maps which are used in dithering post-processing may be repeated every 2k frames (e.g., every 8 frames) to have a 2k-frame period. Alternatively, when 2 lower bits are removed in dithering pre-processing, the red and blue dithering maps which are used in dithering post-processing may be repeated every 4 frames.

In a first frame F1 (see FIG. 6A), each of a first red dithering map and a first blue dithering map may include 16 dithering valid values 1011, 1110, 1101, and 0111. In a second frame F2 (see FIG. 6B), each of a second red dithering map and a second blue dithering map may include 16 dithering valid values 0111, 1101, 1011, and 1110. In a third frame F3 (see FIG. 6C), each of a third red dithering map and a third blue dithering map may include 16 dithering valid values 1110, 1011, 0111, and 1101. In a fourth frame F4 (see FIG. 6D), each of a fourth red dithering map and a fourth blue dithering map may include 16 dithering valid values 1101, 0111, 1110, and 1011. In a fifth frame F5 (see FIG. 6E), each of a fifth red dithering map and a fifth blue dithering map may include 16 dithering valid values 1110, 1101, 0111, and 1011. In a sixth frame F6 (see FIG. 6F), each of a sixth red dithering map and a sixth blue dithering maps may include 16 dithering valid values 1101, 1011, 1110, and 0111. In a seventh frame F7 (see FIG. 6G), each of a seventh red dithering map and a seventh blue dithering map may include 16 dithering valid values 1011, 0111, 1101, and 1110. In an eighth frame F8 (see FIG. 6H), each of an eighth red dithering map and an eighth blue dithering map may include 16 dithering valid values 0111, 1110, 1011, and 1101. Afterwards, the first to eighth red dithering maps and the first to eighth blue dithering maps may be repeated.

The first green dithering map may include dithering valid values respectively corresponding to the first green image signals GL0 to GL15. As illustrated in FIG. 5B and FIG. 5C, two first green dithering maps (i.e., referred to as a “first left green dithering map” and a “first right green dithering map”) may each be arranged in a 4×2 matrix. The first left green dithering map may include 8 dithering valid values 11, 11, 10, and 01 respectively corresponding to eight first green image signals GL0, GL1, GL4, GL5, GL8, GL9, GL12, and GL13, and the first right green dithering map may include 8 dithering valid values 11, 11, 10, and 01 respectively corresponding to eight first green image signals GL2, GL3, GL6, GL7, GL10, GL11, GL14, and GL15. That is, the dithering valid values included in the first left green dithering map may be the same as the dithering valid values included in the first right green dithering map, respectively.

The second green dithering map may include dithering valid values respectively corresponding to the second green image signals GR0 to GR15. As illustrated in FIG. 5B and FIG. 5C, two second green dithering maps (i.e., referred to as a “second left green dithering map” and a “second right green dithering map”) may each be arranged in a 4×2 matrix. The second left green dithering map may include 8 dithering valid values 01, 10, 11, and 11 respectively corresponding to eight second green image signals GR0, GR1, GR4, GR5, GR8, GR9, GR12, and GR13, and the second right green dithering map may include 8 dithering valid values 01, 10, 11, and 11 respectively corresponding to eight second green image signals GR2, GR3, GR6, GR7, GR10, GR11, GR14, and GR15. That is, the dithering valid values included in the second left green dithering map may be the same as the dithering valid values included in the second right green dithering map, respectively.

In the first frame F1, each of the first left green dithering map and the first right green dithering map may include 8 dithering valid values 11, 11, 10, and 01, and each of the second left green dithering map and the second right green dithering map may include 8 dithering valid values 01, 10, 11, and 11. In the second frame F2, each of the first left green dithering map and the first right green dithering map may include 8 dithering valid values 01, 10, 11, and 11, and each of the second left green dithering map and the second right green dithering map may include 8 dithering valid values 11, 11, 01, and 10. In the third frame F3, each of the first left green dithering map and the first right green dithering map may include 8 dithering valid values 11, 11, 01, and 10, and each of the second left green dithering map and the second right green dithering map may include 8 dithering valid values 10, 01, 11, and 11. In the fourth frame F4, each of the first left green dithering map and the first right green dithering map may include 8 dithering valid values 10, 01, 11, and 11, and each of the second left green dithering map and the second right green dithering map may include 8 dithering valid values 11, 11, 10, and 01.

In the fifth frame F5, each of the first left green dithering map and the first right green dithering map may include 8 dithering valid values 11, 10, 01, and 11, and each of the second left green dithering map and the second right green dithering map may include 8 dithering valid values 10, 11, 11, and 01. In the sixth frame F6, each of the first left green dithering map and the first right green dithering map may include 8 dithering valid values 10, 11, 11, and 01, and each of the second left green dithering map and the second right green dithering map may include 8 dithering valid values 11, 01, 10, and 11. In the seventh frame F7, each of the first left green dithering map and the first right green dithering map may include 8 dithering valid values 11, 01, 10, and 11, and each of the second left green dithering map and the second right green dithering map may include 8 dithering valid values 01, 11, 11, and 10. In the eighth frame F8, each of the first left green dithering map and the first right green dithering map may include 8 dithering valid values 01, 11, 11, and 10, and each of the second left green dithering map and the second right green dithering map may include 8 dithering valid values 11, 10, 01, and 11.

The dithering processing unit 120 may perform dithering processing for the red image signals R0 to R15 based on the red dithering map, so as to convert the red image signals R0 to R15 into the red image data R0′ to R15′ and may perform dithering processing for the blue image signals B0 to B15 based on the blue dithering map, so as to convert the blue image signals B0 to B15 into the blue image data B0′ to B15′. The dithering processing unit 120 may perform dithering processing for the first green image signals GL0 to GL15 based on the first green dithering map, so as to convert the first green image signals GL0 to GL15 into the first green image data GL0′ to GL15′ and may perform dithering processing for the second green image signals GR0 to GR15 based on the second green dithering map, so as to convert the second green image signals GR0 to GR15 into the second green image data GR0 to GR15. The dithering valid values of the first green dithering map may be different from the dithering valid values of the second green dithering map.

According to the present disclosure, a value of each of the first green image signals GL0 to GL15 may be the same as a value of each of the second green image signals GR0 to GR15. However, when the first green image data GL0′ to GL15′ are generated by performing dithering processing for the first green image signals GL0 to GL15 based on the first green dithering map and the second green image data GR0′ to GR15′ are generated by performing dithering processing for the second green image signals GR0 to GR15 based on the second green dithering map whose dithering valid values are different from that of the first green dithering map, values of the first green image data GL0′ to GL15′ may be the same as, or different from values of the second green image data GR0′ to GR15′. As illustrated in FIG. 5C, the value of the (1-1)-th green image data GL0′ may be different from the value of the (2-1)-th green image data GR0′, and the value of the (1-5)-th green image data GL4′ may be the same as the value of the (2-5)-th green image data GR4′. The value of the (1-9)-th green image data GL8′ may be the same from the value of the (2-9)-th green image data GR8′, and the value of the (1-13)-th green image data GL12′ may be different from the value of the (2-13)-th green image data GR12′. Meanwhile, the value of the (1-2)-th green image data GL1′ may be the same as the value of the (2-2)-th green image data GR1′, and the value of the (1-6)-th green image data GL5′ may be different from the value of the (2-6)-th green image data GR5′. The value of the (1-10)-th green image data GL9′ may be different from the value of the (2-10)-th green image data GR9′, and the value of the (1-14)-th green image data GL13′ may be the same as the value of the (2-14)-th green image data GR13′.

Referring to FIG. 4 and FIG. 5D, the flag signal generating unit 130 may generate flag signals f0 to f15 based on the dithering map. In particular, the flag signals f0 to f15 may be generated based on the first green dithering map and the second green dithering map.

The flag signal generating unit 130 may compare the dithering valid values 11, 11, 10, and 01 stored in the first left green dithering map with the dithering valid values 11, 11, 10, and 01 stored in the first right green dithering map, respectively and may determine states of the flag signals f0 to f15 depending on a comparison result. For example, when the dithering valid value corresponding to the (1-1)-th green image data GL0′ is “1” and the dithering valid value corresponding to the (2-1)-th green image data GR0′ is “0”, the first flag signal f0 may be deactivated to have a state of logic “0” (i.e., an inactive state). Also, when the dithering valid value corresponding to the (1-2)-th green image data GL1′ is “1” and the dithering valid value corresponding to the (2-2)-th green image data GR1′ is “1”, the second flag signal f1 may be activated to have a state of logic “1” (i.e., an active state). Each of the flag signals f0 to f15 may be activated to have the active state when the first and second green image data corresponding thereto are identical to each other and may be deactivated to have the inactive state when the first and second green image data corresponding thereto are different from each other. Each of the flag signals f0 to f15 may be a 1-bit signal. However, the present disclosure is not limited thereto, and each of the flag signals f0 to f15 may be multi-bit signal.

The combination unit 140 may combine the flag signals f0 to f15 with the red image data R0′ to R15′, the first green image data GL0′ to GL15′, the blue image data B0′ to B15′, and the second green image data GR0′ to GR15′ and may output final image data (f0, R0, GL0, B0, GR0) to (f15, R15, GL15, B15, GR15). When each of the red image data R0′ to R15′, the first green image data GL0′ to GL15′, the blue image data B0′ to B15′, and the second green image data GR0′ to GR15′ is an 8-bit signal, and each of the flag signals f0 to f15 is a 1-bit signal, each of the final image data (f0, R0, GL0, B0, GR0) to (f15, R15, GL15, B15, GR15) may be 33-bit data. However, the present disclosure is not limited thereto, and other encodings may be used.

The data driving circuit 200 (refer to FIG. 3) may receive the red image data R0′ to R15′, the first green image data GL0′ to GL15′, the blue image data B0′ to B15′, and the second green image data GR0′ to GR15′ and convert the received data into a red data signal, a first green data signal, a blue data signal, and a second green data signal. Each of the red data signal, the first green data signal, the blue data signal, and the second green data signal may be a voltage signal of an analog form. The red data signal, the first green data signal, the blue data signal, and the second green data signal may be provided to the display panel DP (refer to FIG. 3).

FIG. 7 is a circuit diagram illustrating a configuration of a selection circuit according to an embodiment of the present disclosure.

Referring to FIG. 3 and FIG. 7, the data driving circuit 200 may be connected to the selection circuit 250 through the fan-out lines FL1 to FLk. For convenience of description, 8 fan-out lines (hereinafter referred to as first to eighth fan-out lines FL1 to FL8) among the k fan-out lines FL1 to FLk are illustrated in FIG. 7, and additional fan-out lines may be omitted from the drawing.

The data driving circuit 200 may include a plurality of output buffers respectively connected to the fan-out lines FL1 to FLk. For convenience of description, 8 output buffers (hereinafter referred to as first to eighth output buffers AMP1 to AMP8), respectively connected to the first to eighth fan-out lines FL1 to FL8, are illustrated in FIG. 7, and additional output buffers may be omitted.

The selection circuit 250 may include a first switching circuit 251, a second switching circuit 252, a third switching circuit 253, and a fourth switching circuit 254. Each of the first to fourth switching circuits 251 to 254 may include k/2 switching elements, but a configuration in which four switching elements are included in each of the first to fourth switching circuits 251 to 254 is illustrated in FIG. 7. That is, the first switching circuit 251 may include (1-1)-th to (1-4)-th switching elements SW11, SW12, SW13, and SW14 receiving a first switching signal TS1 in common, and the second switching circuit 252 may include (2-1)-th to (2-4)-th switching elements SW21, SW22, SW23, and SW24 receiving a second switching signal TS2 in common. The first and second switching signals TS1 and TS2 may be signals which are alternately activated, and thus, the first and second switching circuits 251 and 252 may be alternately turned on. When not turned on, the first and second switching circuits 251 and 252 may be turned off.

Also, the third switching circuit 253 may include (3-1)-th to (3-4)-th switching elements SW31, SW32, SW33, and SW34 receiving a third switching signal TS3 in common, and the fourth switching circuit 254 may include (4-1)-th to (4-4)-th switching elements SW41, SW42, SW43, and SW44 receiving a fourth switching signal TS4 in common. Operations of the third and fourth switching circuits 253 and 254 will be described in detail with reference to FIG. 8A, FIG. 8B, FIG. 9A, and FIG. 9B.

The first fan-out line FL1 (or the first output buffer AMP1) may be connected to the first and third data lines DL1 and DL3 through the (1-1)-th and (2-1)-th switching elements SW11 and SW21, and the second fan-out line FL2 (or the second output buffer AMP2) may be connected to the second and fourth data lines DL2 and DL4 through the (3-1)-th and (4-1)-th switching elements SW31 and SW41. The third fan-out line FL3 (or the third output buffer AMP3) may be connected to the fifth and seventh data lines DL5 and DL7 through the (1-2)-th and (2-2)-th switching elements SW12 and SW22, and the fourth fan-out line FL4 (or the fourth output buffer AMP4) may be connected to the sixth and eighth data lines DL6 and DL8 through the (3-2)-th and (4-2)-th switching elements SW32 and SW42.

The fifth fan-out line FL5 (or the fifth output buffer AMP5) may be connected to the ninth and eleventh data lines DL9 and DL11 through the (1-3)-th and (2-3)-th switching elements SW13 and SW23, and the sixth fan-out line FL6 (or the sixth output buffer AMP6) may be connected to the tenth and twelfth data lines DL10 and DL12 through the (3-3)-th and (4-3)-th switching elements SW33 and SW43. The seventh fan-out line FL7 (or the seventh output buffer AMP7) may be connected to the thirteenth and fifteenth data lines DL13 and DL15 through the (1-4)-th and (2-4)-th switching elements SW14 and SW24, and the eighth fan-out line FL8 (or the eighth output buffer AMP8) may be connected to the fourteenth and sixteenth data lines DL14 and DL16 through the (3-4)-th and (4-4)-th switching elements SW34 and SW44.

Odd-numbered data lines including DL1, DL3, DL5, DL7, DL9, DL11, DL13, and DL15 among the first to sixteenth data lines DL1 to DL16 may be connected to red and blue pixels, and even-numbered data lines including DL2, DL4, DL6, DL8, DL10, DL12, DL14, and DL16 thereof may be connected to green pixels. Red and blue data signals corresponding to red and blue image data may be applied to odd-numbered fan-out lines FL1, FL3, FL5, and FL7 among the first to eighth fan-out lines FL1 to FL8, and first and second green data signals corresponding to first and second green image data may be applied to even-numbered fan-out lines FL2, FL4, FL6, and FL8 thereof. Herein, for convenience of description, red and blue data signals, and first and second green data signals may be expressed as red and blue image data, and first and second green image data, respectively.

The first red image data R0′, the first blue image data B0′, the fifth blue image data B4′, the fifth red image data R4′, the ninth red image data R8′, the ninth blue image data B8′, the thirteenth blue image data B12′, and the thirteenth red image data R12′ may be sequentially applied to the first fan-out line FL1. The second red image data R1′, the second blue image data B1′, the sixth blue image data B5′, the sixth red image data R5′, the tenth red image data R9′, the tenth blue image data B9′, the fourteenth blue image data B13′, and the fourteenth red image data R13′ may be sequentially applied to the third fan-out line FL3.

The third red image data R2′, the third blue image data B2′, the seventh blue image data B6′, the seventh red image data R6′, the eleventh red image data R10′, the eleventh blue image data B10′, the fifteenth blue image data B14′, and the fifteenth red image data R14′ may be sequentially applied to the fifth fan-out line FL5. The fourth red image data R3′, the fourth blue image data B3′, the eighth blue image data B7′, the eighth red image data R7′, the twelfth red image data R11′, the twelfth blue image data B11′, the sixteenth blue image data B15′, and the sixteenth red image data R15′ may be sequentially applied to the seventh fan-out line FL7.

FIG. 8A and FIG. 8B are diagrams for describing operations of third and fourth switching circuits according to an embodiment of the present disclosure.

Referring to FIG. 7, FIG. 8A, and FIG. 8B, the (3-1)-th to (3-4)-th switching elements SW31, SW32, SW33, and SW34 may be turned on during first, third, fifth, and seventh time periods TP1, TP3, TP5, and TP7 in response to the third switching signal TS3. The (4-1)-th to (4-4)-th switching elements SW41, SW42, SW43, and SW44 may be turned on during second, third, fifth, and eighth time periods TP2, TP3, TP5, and TP8 in response to the fourth switching signal TS4. That is, during the third time period TP3 and the fifth time period TP5, the (3-1)-th to (3-4)-th switching elements SW31, SW32, SW33, and SW34 and the (4-1)-th to (4-4)-th switching elements SW41, SW42, SW43, and SW44 may be simultaneously turned on; during the fourth time period TP4 and the sixth time period TP6, the (3-1)-th to (3-4)-th switching elements SW31, SW32, SW33, and SW34 and the (4-1)-th to (4-4)-th switching elements SW41, SW42, SW43, and SW44 may be simultaneously turned off. Herein, the first, third, fifth, and seventh time periods TP1, TP3, TP5, and TP7 may be referred to as a “first selection time period”, and the second, fourth, sixth, and eighth time periods TP2, TP4, TP6, and TP8 may be referred to as a “second selection time period”.

A time period in which the third switching signal TS3 and the fourth switching signal TS4 are simultaneously turned on or are simultaneously turned off may be determined by the flag signals f0 to f15 illustrated in FIG. 4 and FIG. 5D. For example, the flag signals f0 to f15 may be in the inactive state during the first, second, seventh, and eighth time periods TP1, TP2, TP7, and TP8 and may be an active state during the third, fourth, fifth, and sixth time periods TP3, TP4, TP5, and TP6. The simultaneous operation timing of the third switching circuit 253 and the fourth switching circuit 253 is determined by the flag signals f0 to f15. For example, the flag signal f0, which has an inactive state (i.e., f0-0 in FIG. 5D), the (3-1)-th switching element SW31 and the (4-1)-th switching element SW41 are not simultaneously turn on or turned off in the first time period TP1 and the second time period TP2. Similarly, the flag signal f12, which has an inactive state, the (3-1)-th switching element SW31 and the (4-1)-th switching element SW41 are not simultaneously turn on or turned off in the seventh time period TP7 and the eighth time period TP8. Meanwhile, the flag signal f4, which has an active state, the (3-1)-th switching element SW31 and the (4-1)-th switching element SW41 are simultaneously turn on or turned off in the third time period TP3 and the fourth time period TP4, and the flag signal f8, which has an active state, the (3-1)-th switching element SW31 and the (4-1)-th switching element SW41 are simultaneously turn on or turned off in the fifth time period TP5 and the sixth time period TP6.

During the first time period TP1, the (1-1)-th green image data GL0′ applied to the second fan-out line FL2 may be applied to the second data line DL2 through the (3-1)-th switching element SW31; during the second time period TP2, the (2-1)-th green image data GR0′ applied to the second fan-out line FL2 may be applied to the fourth data line DL4 through the (4-1)-th switching element SW41. During the third time period TP3, which is in the first selection time, the (1-5)-th green image data GL4′ applied to the second fan-out line FL2 may be applied to the second and fourth data lines DL2 and DL4 through the (3-1)-th and (4-1)-th switching elements SW31 and SW41, since the (3-1)-th and (4-1)-th switching elements SW31 and SW41 may be turned on at the same time according to the flag f4 (i.e., f4=1). Meanwhile, during the fourth time period TP4, which is in the second selection time, the (2-5)-th green image data GR4′ applied to the second fan-out line FL2 may not be applied to the second and fourth data lines DL2 and DL4 by the (3-1)-th and (4-1)-th switching elements SW31 and SW41, since the (3-1)-th and (4-1)-th switching elements SW31 and SW41 may be turned off at the same time according to the flag f4.

During the first time period TP1, the (1-6)-th green image data GL5′ applied to the fourth fan-out line FL4 may be applied to the sixth data line DL6 through the (3-2)-th switching element SW32; during the second time period TP2, the (2-6)-th green image data GR5′ applied to the fourth fan-out line FL4 may be applied to the eighth data line DL8 through the (4-2)-th switching element SW42. During the third time period TP3, which is in the first selection time, the (1-2)-th green image data GL1′ applied to the fourth fan-out line FL4 may be applied to the sixth and eighth data lines DL6 and DL8 through the (3-2)-th and (4-2)-th switching elements SW32 and SW42, since the (3-2)-th and (4-2)-th switching elements SW32 and SW42 may be turned on at the same time according to the flag f1. Meanwhile, during the fourth time period TP4, which is in the second selection time, the (2-2)-th green image data GR1′ applied to the fourth fan-out line FL4 may not be applied to the sixth and eighth data lines DL6 and DL8 by the (3-2)-th and (4-2)-th switching elements SW32 and SW42, since the (3-2)-th and (4-2)-th switching elements SW32 and SW42 may be turned off at the same time according to the flag f1.

As described above, as the activation timing of the fourth switching signal TS4 may be changed by the flag signals f0 to f15, the number of times the fourth switching elements SW41 to SW44 are toggled may be reduced, and power consumption of the selection circuit 250 may be reduced.

Accordingly, the combination unit 140 (refer to FIG. 4) according to the present disclosure may change an order of outputting the first and second green image data from different fan-out lines to match each other by referring to the flag signals f0 to f15, such that image data associated with a same state (e.g., active state or inactive state) may be output at a same time period.

For example, in FIG. 8A and FIG. 8B, the (1-6)-th green image data GL5′ and the (2-6)-th green image data GR5′, which are associated with flag signal f5 having an inactive state, may be applied to the fourth fan-out line FL4 at the first time period TP1 and the second time period TP2, before the (1-2)-th green image data GL1′ may be applied to the fourth fan-out line FL4 at the third time period TP3. That is, the (1-6)-th green image data GL5′ and the (2-6)-th green image data GR5′, which are associated with flag signal f5 having an inactive state, may be applied to the fourth fan-out line FL4 at the first time period TP1 and the second time period TP2, respectively, while the (1-1)-th green image data GL0′ and the (2-1)-th green image data GR0′, which are associated with flag signal f0 having an inactive state, may be applied to the second fan-out line FL2 at the first time period TP1 and the second time period TP2, respectively. Further, the (1-14)-th green image data GL13′ may be applied to the fourth fan-out line FL4 at the fifth time period TP5 before the (1-10)-th green image data GL9′ may be applied to the fourth fan-out line FL4 at the seventh time period TP7. Also, the (1-8)-th green image data GL7′ and the (2-8)-th green image data GR7′ may be first applied to the fourth fan-out line FL4 at the first time period TP1 and the second time period TP2 before the (1-4)-th green image data GL3′ may be applied to the fourth fan-out line FL4 at the third time period TP3, and the (1-16)-th green image data GL15′ may be first applied to the fourth fan-out line FL4 at the fifth time period TP5 before the (1-12)-th green image data GL11′ may be applied to the fourth fan-out line FL4 at the seventh time period TP7.

The number of times that each of the (4-1)-th to (4-4)-th switching elements SW41 and SW44 are toggled by the fourth switching signal TS4 may be reduced. In particular, as illustrated in FIG. 8B, each of the (4-1)-th to (4-4)-th switching elements SW41 and SW44 may not be toggled between the second time period TP2 and the third time period TP3, or between the sixth time period TP6 and the seventh time period TP7. For example, each of the (4-1)-th to (4-4)-th switching elements SW41 and SW44 may be turned on during the second time period TP2 and the third time period TP3, and may be turned off during the sixth time period TP6 and the seventh time period TP7. Accordingly, the combination unit 140 (refer to FIG. 4) according to the present disclosure may change an order of outputting the first and second green image data from the fourth fan-out line FL4 into an order of outputting the first and second green image data from the second fan-out line FL2, by referring to the flag signals f0 to f15. Similarly, the combination unit 140 according to the present disclosure may change an order of outputting the first and second green image data from the eight fan-out line FL8 into an order of outputting the first and second green image data from the sixth fan-out line FL6, by referring to the flag signals f0 to f15.

FIG. 9A and FIG. 9B are diagrams for describing operations of third to sixth switching circuits according to an embodiment of the present disclosure.

Referring to FIG. 9A and FIG. 9B, a selection circuit 250a according to an embodiment of the present disclosure may include first to sixth switching circuits 251, 252, 253a, 254a, 255, and 256. Here, the first and second switching circuits 251 and 252 may be the same as the first and second switching circuits 251 and 252 illustrated in FIG. 7, and are omitted from the illustration of FIG. 9A for purposes of clarity.

The third switching circuit 253a may include (3-1)-th to (3-2)-th switching elements SW3a and SW3b receiving the third switching signal TS3 in common, and the fourth switching circuit 254a may include (4-1)-th and (4-2)-th switching elements SW4a and SW4b receiving the fourth switching signal TS4 in common. The fifth switching circuit 255 may include (5-1)-th and (5-2)-th switching elements SW5a and SW5b receiving a fifth switching signal TS5 in common, and the sixth switching circuit 256 may include (6-1)-th and (6-2)-th switching elements SW6a and SW6b receiving a sixth switching signal TS6 in common.

The (3-1)-th and (3-2)-th switching elements SW3a and SW3b may be turned on during first, third, fifth, and seventh time periods TP1, TP3, TP5, and TP7 in response to the third switching signal TS3. The (4-1)-th and (4-2)-th switching elements SW4a and SW4b may be turned on during second, third, fifth, and eighth time periods TP2, TP3, TP5, and TP8 in response to the fourth switching signal TS4. That is, during the third time period TP3 and the fifth time period TP5, the (3-1)-th and (3-2)-th switching elements SW3a and SW3b and the (4-1)-th and (4-2)-th switching elements SW4a and SW4b may be simultaneously turned on; during the fourth time period TP4 and the sixth time period TP6, the (3-1)-th and (3-2)-th switching elements SW3a and SW3b and the (4-1)-th and (4-2)-th switching elements SW4a and SW4b may be simultaneously turned off.

The (5-1)-th and (5-2)-th switching elements SW5a and SW5b may be turned on during first, third, fifth, and seventh time periods TP1, TP3, TP5, and TP7 in response to the fifth switching signal TS5. The (6-1)-th and (6-2)-th switching elements SW6a and SW6b may be turned on during first, fourth, sixth, and seventh time periods TP1, TP4, TP6, and TP7 in response to the sixth switching signal TS6. That is, during the first time period TP1 and the seventh time period TP7, the (5-1)-th and (5-2)-th switching elements SW5a and SW5b and the (6-1)-th and (6-2)-th switching elements SW6a and SW6b may be simultaneously turned on; during the second time period TP2 and the eighth time period TP8, the (5-1)-th and (5-2)-th switching elements SW5a and SW5b and the (6-1)-th and (6-2)-th switching elements SW6a and SW6b may be simultaneously turned off.

As the activation timing of the fourth switching signal TS4 and the activation timing of the sixth switching signal TS6 may be respectively changed by the flag signals f0 to f15, the number of times the fourth switching elements SW4a and SW4b may be toggled, and the number of times the sixth switching elements SW6a and SW6b may be toggled may be reduced. In particular, as illustrated in FIG. 9B, each of the fourth switching elements SW4a and SW4b and the sixth switching elements SW6a and SW6b may not be toggled between the second time period TP2 and the third time period TP3, or between the sixth time period TP6 and the seventh time period TP7. For example, the fourth switching elements SW4a and SW4b may be turned on during the second time period TP2 and the third time period TP3 and may be turned off during the sixth time period TP6 and the seventh time period TP7. Accordingly, the power consumption of the selection circuit 250a may be reduced.

Also, the second fan-out line FL2 (or the first green output buffer AMP2) may be connected to the third and fourth switching circuits 253a and 254a and the fourth fan-out line FL4 (or the second green output buffer AMP2) may be connected to the fifth and sixth switching circuits 255 and 256. In a case where the second fan-out line FL2 and the fourth fan-out line FL4 are connected to different switching circuits, there may be no need to change the output of outputting the first and second green image data from the fourth fan-out line FL4 into the order of outputting the first and second green image data from the second fan-out line FL2, and a combination unit may be omitted.

The selection circuit 250a illustrated in FIG. 9A may include switching circuits (i.e., the fifth and sixth switching circuits 255 and 256). Accordingly, when the non-effective area NAA (refer to FIG. 3) secured in the display panel DP is sufficient to conceal the selection circuit 250a, the selection circuit 250a may be disposed in the non-effective area NAA of the display panel DP; however, when the non-effective area NAA (refer to FIG. 3) of the display panel DP has a small area or is omitted, the selection circuit 250a may be embedded in the data driving circuit 200.

FIG. 10 is a block diagram of a driving controller according to an embodiment of the present disclosure. FIG. 11 is a diagram illustrating red, green, and blue image data according to an embodiment of the present disclosure. FIG. 12 is a circuit diagram illustrating a configuration of a selection circuit according to an embodiment of the present disclosure. Components, which are substantially the same as the components illustrated in FIG. 4, FIG. 5C, and FIG. 7, from among components illustrated in FIG. 10, FIG. 11, and FIG. 12 may be marked by the same reference signs/numerals, and additional description thereof may be omitted or summarized to avoid redundancy.

Referring on the FIG. 10, a driving controller 100a may include the rendering processing unit 110 and a dithering processing unit 120a.

The rendering processing unit 110 may perform rendering processing for the red input image signals R(0,0) to R(15,1) to generate the red image signals R0 to R15 and may perform rendering processing for the blue input image signals B(0,0) to B(15,1) to generate the blue image signals B0 to B15. Also, the rendering processing unit 110 may perform rendering processing for the green input image signals G(0,0) to G(15,1) to generate the first green image signals GL0 to GL15 and the second green image signals GR0 to GR15. The rendering processing unit 110 of FIG. 10 may be the same as the rendering processing unit 110 illustrated in FIG. 4, and additional description thereof may be omitted or summarized to avoid redundancy.

The dithering processing unit 120a may receive the red image signals R0 to R15, the first green image signals GL0 to GL15, the blue image signals B0 to B15, and the second green image signals GR0 to GR15 from the rendering processing unit 110. The dithering processing unit 120a may perform dithering processing for the red image signals R0 to R15 and the blue image signals B0 to B15 based on a preset dithering map, so as to convert the red image signals R0 to R15 and the blue image signals B0 to B15 into the red image data R0′ to R15′ and the blue image data B0′ to B15′.

The dithering processing may include dithering pre-processing, which may remove “k” lower bits of a p-bit image signal so as to convert the p-bit image signal into a q-bit image signal and dithering post-processing, which may add a dither bit to the q-bit image signal based on a dithering map so as to convert the q-bit image signal into q-bit image data.

The dithering processing unit 120a may omit the dithering post-processing for the first green image signals GL0 to GL15 and the second green image signals GR0 to GR15. That is, the dithering processing unit 120a may perform the dithering pre-processing for the first green image signals GL0 to GL15 and the second green image signals GR0 to GR15 to generate first green image data GL0″ to GL15″ and second green image data GR0″ to GR15″ and may omit the dithering post-processing. As an embodiment of the present disclosure, each of the red image data R0′ to R15′, the first green image data GL0″ to GL15″, the blue image data B0′ to B15′, and the second green image data GR0″ to GR15″ may be an 8-bit signal.

The first green image data GL0″ to GL15″ and the second green image data GR0″ to GR15″ generated through the dithering pre-processing may be the same signals. That is, the first green image data GL0″ to GL15″ and the second green image data GR0″ to GR15″ generated through the dithering pre-processing may be matching signals. For example, as illustrated in FIG. 11, the value of the (1-1)-th green image data GL0″ may be the same as the value of the (2-1)-th green image data GR0″, and the value of the (1-5)-th green image data GL4″ may be the same as the value of the (2-5)-th green image data GR4″. The value of the (1-9)-th green image data GL8″ may be the same as the value of the (2-9)-th green image data GR8″, and the value of the (1-13)-th green image data GL12″ may be same as the value of the (2-13)-th green image data GR12″. Also, the value of the (1-2)-th green image data GL1″ may be the same as the value of the (2-2)-th green image data GR1″, and the value of the (1-6)-th green image data GL5″ may be same as the value of the (2-6)-th green image data GR5″. The value of the (1-10)-th green image data GL9″ may be the same as the value of the (2-10)-th green image data GR9″, and the value of the (1-14)-th green image data GL13″ may be same as the value of the (2-14)-th green image data GR13″.

Referring to FIG. 12, a selection circuit 250b may include the first switching circuit 251 and the second switching circuit 252. That is, the selection circuit 250b may not include the third switching circuit 253 and the fourth switching circuit 254 illustrated in FIG. 7.

The first fan-out line FL1 (or the first output buffer AMP1) may be connected to the first and third data lines DL1 and DL3 through the (1-1)-th and (2-1)-th switching elements SW11 and SW21, and the second fan-out line FL2 (or the second output buffer AMP2) may be directly connected to the second and fourth data lines DL2 and DL4 in common. The third fan-out line FL3 (or the third output buffer AMP3) may be connected to the fifth and seventh data lines DL5 and DL7 through the (1-2)-th and (2-2)-th switching elements SW12 and SW22, and the fourth fan-out line FL4 (or the fourth output buffer AMP4) may be directly connected to the sixth and eighth data lines DL6 and DL8 in common. The fifth fan-out line FL5 (or the fifth output buffer AMP5) may be connected to the ninth and eleventh data lines DL9 and DL11 through the (1-3)-th and (2-3)-th switching elements SW13 and SW23, and the sixth fan-out line FL6 (or the sixth output buffer AMP6) may be directly connected to the tenth and twelfth data lines DL10 and DL12 in common. The seventh fan-out line FL7 (or the seventh output buffer AMP7) may be connected to the thirteenth and fifteenth data lines DL13 and DL15 through the (1-4)-th and (2-4)-th switching elements SW14 and SW24, and the eighth fan-out line FL8 (or the eighth output buffer AMP8) may be directly connected to the fourteenth and sixteenth data lines DL14 and DL16 in common.

The (1-1)-th green image data GL0″ and (2-1)-th green image data GR0″ applied to the second fan-out line FL2 may be provided in common to the second and fourth data lines DL2 and DL4, and the (1-2)-th green image data GL1″ and (2-2)-th green image data GR1″ applied to the fourth fan-out line FL4 may be provided in common to the sixth and eighth data lines DL6 and DL8.

As described above, as the dithering post-processing for the first and second green image data may be omitted, the first and second green image data may have the same values, and the third switching circuit 253 and the fourth switching circuit 254 may be omitted in the selection circuit 250b. Accordingly, the power consumption of the selection circuit 250b may be further reduced.

According to the present disclosure, latch data corresponding to each channel of a data driving circuit may be compared with previous latch data, and a bias current of an output buffer connected to each channel may be controlled depending on a comparison result. That is, a total of power consumption of the data driving circuit may be efficiently reduced by independently controlling the power consumption of each of a plurality of output buffers provided in the data driving circuit.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A display device comprising:
a driving controller configured to perform rendering processing for a red input image signal, a green input image signal, and a blue input image signal to generate a red image signal, a first green image signal, a blue image signal, and a second green image signal, and to convert the red image signal, the first green image signal, the blue image signal, and the second green image signal into red image data, first green image data, blue image data, and second green image data;
a data driving circuit configured to convert the red image data, the first green image data, the blue image data, and the second green image data into a red data signal, a first green data signal, a blue data signal, and a second green data signal;
a selection circuit connected to the data driving circuit, and configured to selectively output the red data signal, the first green data signal, the blue data signal, and the second green data signal; and
a display panel configured to receive the red data signal, the first green data signal, the blue data signal, and the second green data signal and to display an image,
wherein at least an n-th value of the first green image signal and an n-th value of the second green image signal a same value.

2. The display device of claim 1, wherein the driving controller includes:
a rendering processing unit configured to perform the rendering processing for the red input image signal, the green input image signal, and the blue input image signal to generate the red image signal, the first green image signal, the blue image signal, and the second green image signal;
a dithering processing unit configured to perform dithering processing for the red image signal, the first green image signal, the blue image signal, and the second green image signal using a dithering map to convert the red image signal, the first green image signal, the blue image signal, and the second green image signal into the red image data, the first green image data, the blue image data, and the second green image data; and
a flag signal generating unit configured to generate a flag signal based on the dithering map.

3. The display device of claim 2, wherein the data driving circuit includes:
a first output buffer configured to alternately output the red data signal and the blue data signal; and
a second output buffer configured to alternately output the first green data signal and the second green data signal,
wherein the selection circuit includes:
a first switching circuit connected to the first output buffer, and configured to be activated in response to a first switching signal;
a second switching circuit connected to the first output buffer, and configured to be activated in response to a second switching signal;
a third switching circuit connected to the second output buffer, and configured to be activated in response to a third switching signal; and
a fourth switching circuit connected to the second output buffer, and configured to be activated in response to a fourth switching signal,
wherein activation timings of the third switching signal and the fourth switching signal are determined by the flag signal.

4. The display device of claim 3, wherein the first switching circuit includes:
a first switching element disposed between the first output buffer and a first data line of the display panel, and configured to operate in response to the first switching signal,
wherein the second switching circuit includes:
a second switching element disposed between the first output buffer and a third data line of the display panel, and configured to operate in response to the second switching signal,
wherein the third switching circuit includes:
a third switching element disposed between the second output buffer and a second data line of the display panel, and configured to operate in response to the third switching signal, and
wherein the fourth switching circuit includes:
a fourth switching element disposed between the second output buffer and a fourth data line of the display panel, and configured to operate in response to the fourth switching signal.

5. The display device of claim 4, wherein the dithering processing unit is configured to:
perform the dithering processing for the red image signal based on a first dithering map;
perform the dithering processing for the blue image signal based on a second dithering map;
perform the dithering processing for the first green image signal based on a third dithering map; and
perform the dithering processing for the second green image signal based on a fourth dithering map.

6. The display device of claim 5, wherein, when a first green dithering valid value stored in the third dithering map and a second green dithering valid value stored in the fourth dithering map have a same value, the first green image data and the second green image data have a same value, and the flag signal is activated,
wherein, when the flag signal is activated, the third switching signal and the fourth switching signal are simultaneously activated during a first selection time period and are simultaneously deactivated during a second selection time period,
wherein, when the first green dithering valid value stored in the third dithering map is different from the second green dithering valid value stored in the fourth dithering map, the first green image data and the second green image data have different values, and the flag signal is deactivated, and
wherein, when the flag signal is deactivated, the third switching signal is activated during a first selection time period, and the fourth switching signal is activated during a second selection time period.

7. The display device of claim 6, wherein each of the red image signal, the first green image signal, the blue image signal, and the second green image signal is a p-bit signal,
wherein each of the red image data, the first green image data, the blue image data, and the second green image data is a q-bit signal, and
wherein, p and q are each an integer greater than 0, and q is smaller than p.

8. The display device of claim 7, wherein each of the first to fourth dithering maps is repeated at a 2k-frame period, and
wherein k is an integer greater than 0, and k corresponds to p-q.

9. The display device of claim 7, wherein the dithering processing unit is configured to:
when a first green dithering valid value is logic “1”, convert the first green image signal into the first green image data of q bits and add a dither bit to the first green image data;
when the first green dithering valid value is logic “0”, convert the first green image signal into the first green image data of the q bits;
when a second green dithering valid value is logic “1”, convert the second green image signal into the second green image data of q bits and add the dither bit to the second green image data; and
when the second green dithering valid value is logic “0”, convert the second green image signal into the second green image data of the q bits.

10. The display device of claim 2, wherein the data driving circuit includes:
a first output buffer configured to alternately output the red data signal and the blue data signal;
a first green output buffer configured to alternately output the first green data signal and the second green data signal; and
a second green output buffer configured to alternately output the first green data signal and the second green data signal,
wherein the selection circuit includes:
a first switching circuit connected to the first output buffer, and configured to be activated in response to a first switching signal;
a second switching circuit connected to the first output buffer, and configured to be activated in response to a second switching signal;
a third switching circuit connected to the first green output buffer, and configured to be activated in response to a third switching signal;
a fourth switching circuit connected to the first green output buffer, and configured to be activated in response to a fourth switching signal;
a fifth switching circuit connected to the second green output buffer, and configured to be activated in response to a fifth switching signal; and
a sixth switching circuit connected to the second green output buffer, and configured to be activated in response to as a sixth switching signal,
wherein activation timings of the third switching signal to the sixth switching signal are determined by the flag signal.

11. The display device of claim 10, wherein the first switching circuit includes:
a first switching element disposed between the first output buffer and a first data line of the display panel, and configured to operate in response to the first switching signal,
wherein the second switching circuit includes:
a second switching element disposed between the first output buffer and a third data line of the display panel, and configured to operate in response to the second switching signal,
wherein the third switching circuit includes:
a third switching element disposed between the first green output buffer and a second data line of the display panel, and configured to operate in response to the third switching signal,
wherein the fourth switching circuit includes:
a fourth switching element disposed between the first green output buffer and a fourth data line of the display panel, and configured to operate in response to the fourth switching signal,
wherein the fifth switching circuit includes:
a fifth switching element disposed between the second green output buffer and a sixth data line of the display panel, and configured to operate in response to the fifth switching signal, and
wherein the sixth switching circuit includes:
a sixth switching element disposed between the second green output buffer and an eighth data line of the display panel, and configured to operate in response to the sixth switching signal.

12. The display device of claim 1, wherein the data driving circuit includes:
a first output buffer configured to alternately output the red data signal and the blue data signal; and
a second output buffer configured to alternately output the first green data signal and the second green data signal, wherein the first green image data and the second green image data are matching signals,
wherein the selection circuit includes:
a first switching element disposed between the first output buffer and a first data line of the display panel, and configured to operate in response to the first switching signal; and
a second switching element disposed between the first output buffer and a third data line of the display panel, and configured to operate in response to the second switching signal, wherein the second output buffer is connected to a second data line and a fourth data line of the display panel in common.

13. A display device comprising:
a dithering processing unit configured to perform dithering processing for a first red image signal and a first blue image signal based on a dithering map, and to perform dithering pre-processing for a first green image signal and a second green image signal to convert the first red image signal, the first green image signal, the first blue image signal, and the second green image signal into first red image data, first green image data, first blue image data, and second green image data;
a data driving circuit configured to convert the first red image data, the first green image data, the first blue image data, and the second green image data into a first red data signal, a first green data signal, a first blue data signal, and a second green data signal;
a selection circuit connected to the data driving circuit and including a first switching circuit and a second switching circuit selectively outputting the first red data signal, the first green data signal, the first blue data signal, and the second green data signal; and
a display panel configured to receive the first red data signal, the first green data signal, the first blue data signal, and the second green data signal and to display an image,
wherein the first green image data and the second green image data are matching signals.

14. The display device of claim 13, wherein the data driving circuit includes:
a first output buffer configured to alternately output the first red data signal and the first blue data signal; and
a second output buffer configured to alternately output the first green data signal and the second green data signal,
wherein the selection circuit includes:
a first switching element disposed between the first output buffer and a first data line of the display panel, and configured to operate in response to a first switching signal; and
a second switching element disposed between the first output buffer and a third data line of the display panel, and configured to operate in response to a second switching signal, and
wherein the second output buffer is connected to a second data line and a fourth data line of the display panel in common.

15. The display device of claim 13, wherein each of the first red image signal and the first blue image signal is a p-bit signal,
wherein the dithering processing unit configured to perform the dithering processing for the first red image signal and the first blue image signal is further configured to perform a dithering pre-processing for removing k lower bits of the first red image signal and the first blue image signal to convert the first red image signal and the first blue image signal into q-bit image signals and to perform a dithering post-processing selectively adding a dither bit to the first red image signal and the first blue image signal based on a dithering map to convert the first red image signal and the first blue image signal into the first red image data and the first blue image data, and
wherein p and q are each an integer greater than 0, and q is smaller than p.

16. The display device of claim 13, wherein each of the first green image signal and the second green image signal is a p-bit signal,
wherein the dithering processing unit configured to perform the dithering pre-processing for the first green image signal and the second green image signal is further configured for removing k lower bits of the first green image signal and the second green image signal to convert the first green image signal and the second green image signal into the first green image data and the second green image data, which are q-bit image signals, and
wherein p and q are each an integer greater than 0, and q is smaller than p.

17. A display device comprising:
a rendering processing unit configured to receive a red input image signal, a green input image signal, and a blue input image signal and to perform rendering processing for the red input image signal, the green input image signal, and the blue input image signal to generate a first red image signal, a first green image signal, a first blue image signal, and a second green image signal;
a dithering processing unit configured to perform dithering processing for the first red image signal, the first green image signal, the first blue image signal, and the second green image signal based on a dithering map, so as to be converted into first red image data, first green image data, first blue image data, and second green image data;
a flag signal generating unit configured to generate a flag signal based on the dithering map;
a data driving circuit configured to receive the first red image data, the first green image data, the first blue image data, and the second green image data and to convert the first red image data, the first green image data, the first blue image data, and the second green image data into a first red data signal, a first green data signal, a first blue data signal, and a second green data signal;
a selection circuit connected to the data driving circuit and including a first switching circuit and a second switching circuit selectively outputting the first red data signal and the first blue data signal and a third switching circuit and a fourth switching circuit selectively outputting the first green data signal and the second green data signal; and
a display panel configured to receive the first red data signal, the first green data signal, the first blue data signal, and the second green data signal and to display an image,
wherein a simultaneous operation timing of the third switching circuit and the fourth switching circuit are determined by the flag signal.

18. The display device of claim 17, wherein the data driving circuit includes:
a first output buffer configured to alternately output the first red data signal and the first blue data signal; and
a second output buffer configured to alternately output the first green data signal and the second green data signal,
wherein the selection circuit includes:
a first switching circuit connected to the first output buffer, and configured to be activated in response to a first switching signal;
a second switching circuit connected to the first output buffer, and configured to be activated in response to a second switching signal;
a third switching circuit connected to the second output buffer, and configured to be activated in response to a third switching signal; and
a fourth switching circuit connected to the second output buffer, and configured to be activated in response to a fourth switching signal,
wherein activation timings of the third switching signal and the fourth switching signal are determined by the flag signal.

19. The display device of claim 18, wherein the dithering processing unit is configured to:
perform the dithering processing for the first red image signal based on a first dithering map; and
perform the dithering processing for the first blue image signal based on a second dithering map;
perform the dithering processing for the first green image signal based on a third dithering map; and
perform the dithering processing for the second green image signal based on a fourth dithering map.

20. The display device of claim 19, wherein, when a first green dithering valid value stored in the third dithering map and a second green dithering valid value stored in the fourth dithering map have a same value, the first green image data and the second green image data have a same value,
wherein, when the first green dithering valid value stored in the third dithering map is different from the second green dithering valid value stored in the fourth dithering map, the first green image data and the second green image data have different values,
wherein, when the first green dithering valid value and the second green dithering valid value have a same value, the flag signal is activated,
wherein, when the flag signal is activated, the third switching signal and the fourth switching signal are simultaneously activated during a first selection time period and are simultaneously deactivated during a second selection time period,
wherein, when the first green dithering valid value is different from the second green dithering valid value, the flag signal is deactivated, and
wherein, when the flag signal is deactivated, the third switching signal is activated during the first selection time period, and the fourth switching signal is activated during the second selection time period.
